(19) United States
(12) Patent Application Publication
(10) Pub. No.: US 2023/0002658 A1
(43) Pub. Date: Jan. 5, 2023

(54) COMPOSITIONS OF HFO-1234YF AND R-161 AND SYSTEMS FOR USING THE COMPOSITIONS

(71) Applicant: THE CHEMOURS COMPANY FC, LLC, WILMINGTON, DE (US)

(72) Inventors: MARY E KOBAN, CHADDS FORD, PA (US); LUKE DAVID SIMONI, WILMINGTON, DE (US); XUEHUI SUN, KENNETT SQUARE, PA (US); KARL ROBERT KRAUSE, KENNETT SQUARE, PA (US)

(73) Assignee: THE CHEMOURS COMPANY FC, LLC, WILMINGTON, DE (US)

(21) Appl. No.: 17/784,738

(22) PCT Filed: Dec. 17, 2020
(86) PCT No.: PCT/US20/65600

§ 371 Date: Jun. 13, 2022

Related U.S. Application Data
(60) Provisional application No. 62/949,512, filed on Dec. 18, 2019.
(60) Provisional application No. 63/017,011, filed on Apr. 29, 2020.
(60) Provisional application No. 63/056,000, filed on Jul. 24, 2020.

(51) Int. Cl. C09K 5/04; F25B 41/24; C10M 171/00

(52) U.S. Cl. CPC C09K 5/045; F25B 41/24; C10M 171/008; C09K 2205/126; C09K 2205/22; C09K 2205/32; F25B 2400/121; C10M 2213/0606; C10N 2020/101

(57) ABSTRACT

Environmentally friendly refrigerant blends utilizing blends including 2,3,3,3-tetrafluoropropene (HFO-1234yf) and fluoroethane (HFC-161). The blends have ultra-low GWP, low toxicity, and low flammability with low temperature glide or nearly negligible glide for use in a hybrid, mild hybrid, plug-in hybrid, or full electric vehicles for thermal management (transferring heat from one part of the vehicle to the other) of the passenger compartment providing air conditioning (A/C) or heating to the passenger cabin.

This Application claims the benefit of Application Nos. 62/949,512, filed on Dec. 19, 2019, 63/017,011, filed on Apr. 29, 2020 and 63/056,000, filed on Jul. 24, 2020. The disclosure of Application Nos. 62/949,512; 63/017,011 and 63/056,000 is hereby incorporated by reference.

### FIELD

The present invention is directed to compositions comprising HFO-1234yf and R-161 including azeotropic and near azeotropic compositions of HFO-1234yf and R-161.

### BACKGROUND

The automotive industry is going through an architecture platform rejuvenation from using an internal combustion engine (ICE) for propulsion to using electric batteries for propulsion. This platform rejuvenation is severely limiting the size of the internal combustion engine (ICE) in hybrid, plug-in hybrid vehicles or possibly eliminating the ICE altogether in pure electric vehicles. Some vehicles still maintain an ICE and are noted as hybrid electric vehicle (HEV) or plug-in hybrids electric vehicle (PHEV) or mild hybrids electric vehicles (MHEV). Vehicles which are fully electric and have no ICE are denoted as full EVs. All HEV, PHEV, MHEV and EVs use at least one electric motors, where the electric motor provides some form of propulsion for the vehicles normally provided by the internal combustion engine (ICE) found in gasoline/diesel powered vehicles.

In electrified vehicles, the ICE is typically reduced in size (HEV, PHEV, or MHEV) or eliminated (EV) to reduce vehicle weight thereby increasing the electric drive-cycle. While the ICE's primary function is to provide vehicle propulsion, it also provides heat to the passenger cabin as its secondary function. Typically, heating is required when ambient conditions are 10° C. or lower. In a non-electrified vehicle, there is excess heat from the ICE, which can be scavenged and used to heat the passenger cabin. It should be noted that while the ICE may take some time (several minutes) to heat up and generate heat, it functions well to temperatures of −30° C. Therefore, in electrified vehicles, ICE size reduction or elimination is creating a demand for effective heating of the passenger cabin using a heat pump type fluid, i.e., a heat transfer fluid or working fluid which is capable of being used in the heating, and/or in the cooling mode as the needs of the passenger cabin and battery management require heating and cooling.

Due to environmental pressures, the current automotive refrigerant, R-134a, a hydrofluorocarbon or HFC, is being phased out in favor of lower global warming potential (GWP) refrigerants with GWP<150. While HFO-1234yf, a hydrofluoro-olefin, meets the low GWP requirement (GWP=4 per Pappadimitriou and GWP <1 per AR5), it has lower refrigeration capacity and cannot fully meet the heating needs at low (−10° C.) to very low (−30° C.) ambient temperatures typically, without some type of system alteration or working fluid change. Examples of compositions comprising HFO-1234yf are disclosed in WO2007/126414; the disclosure of which is hereby incorporated by reference.

Similarly, the heating and cooling of stationary residential and commercial structures also suffers from a lack of suitable low GWP refrigerants to replace the older high GWP refrigerants currently in use.

Therefore, there is a need for low GWP heat pump type fluids to meet the ever-increasing needs of hybrid, mild hybrid, plug-in hybrid and electric vehicles, electrified mass transport, and residential and commercial structures for thermal management which can provide cooling and heating.

### SUMMARY

The present invention relates to compositions of environmentally friendly refrigerant blends with ultra-low GWP, (GWP less than or equal to 10 GWP) low toxicity (class A per ANSI/ASHRAE standard 34 or ISO standard 817)), and low flammability (class 2 or class 2L per ASHRAE 34 or ISO 817) with low temperature glide (less than 3K) or nearly negligible glide (less than 0.75K) for use in a hybrid, mild hybrid, plug-in hybrid, or full electric vehicles for thermal management (transferring heat from one part of the vehicle to the other) of the passenger compartment providing air conditioning (A/C) or heating to the passenger cabin. These refrigerants can also be used for mass transport mobile applications which benefit from heat pump type heating or cooling of passenger cabin areas. Mass transport mobile applications are not limited to, but can include transport vehicles such as ambulances, buses, shuttles, and trains.

Compositions of the present invention exhibit low temperature glide over the operating conditions of vehicle thermal management systems. In one aspect of the invention, the refrigerant compositions include mixtures of HFO-1234yf and fluoroethane exhibiting near-azeotropic behavior. In another aspect of the invention, the refrigerant compositions include mixtures of HFO-1234yf and fluoroethane exhibiting azeotropic-like behavior. Due to the manner in which automotive vehicles are repaired or serviced, the fluid must have low or negligible glide. Currently, during the vehicle A/C repair or service process, refrigerant is handled through specific automotive service machines which recover the refrigerant, recycle the refrigerant to some intermittent quality level removing gross contaminants and then recharge the refrigerant back into the vehicle after repairs or servicing have been completed. These machines are denoted as R/R/R machines since they recover, recycle, recharge refrigerant. It is this on-site recovery, recycle and recharge of refrigerant during vehicle maintenance or repair, that low glide is preferable and negligible glide most preferable to prevent composition shift. The current automotive service machines are not typically capable of handling refrigerant with high glide or glide. Since the refrigerant is handled “on-site” at a vehicle repair shop, there is no opportunity to reconstitute a blend refrigerant to the correct composition such as is done at a refrigerant recycler. Refrigerants with higher glide can sometimes require “reconstitution” to the original formulation otherwise there will be a loss in cycle performance. Therefore, there is a need for refrigerants which have low or no glide for automotive applications. Since a heat pump fluid would be handled in the same manner as the air-conditioning fluid, this requirement for low or no glide would also apply for a heat pump type fluid as it would be handled and/or serviced in the same manner as the traditional air-conditioning fluids.

While HFO-1234yf can be used as an air-conditioning refrigerant, it may be limited in its ability to perform as a heat pump type fluid, i.e., capable of operating in cooling or heating modes or in a reversible cycle system. Therefore, the refrigerants noted herein uniquely provide improved capacity over HFO-1234yf in the heating operating range, and/or extend the lower heating range capability over HFO-1234yf to −30° C., have extremely low GWP and low to mild flammability, while also uniquely exhibiting low or nearly negligible temperature glide. Hence these refrigerants are most useful in electrified vehicle applications, particularly HEV, PHEV, MHEV, EV and mass transport vehicles which require these properties over the lower end heating range. It should also be noted that any heat pump type fluid also needs to perform well in the air-conditioning range, i.e., up to 40° C., providing increased or equivalent capacity versus HFO-1234yf. Therefore, the refrigerant blends noted herein perform well over a range of temperatures, particularly from −30° C. up to +40° C. and can provide heating or cooling depending upon which cycle they are being used in the heat pump system.

The present invention includes the following aspects and embodiments:
In one embodiment, disclosed herein are compositions useful as refrigerants and heat transfer fluids. The compositions disclosed herein comprise: 2,3,3,3-tetrafluoropropene (HFO-1234yf) and fluoroethane (HFC-161), including wherein the composition can be near-azeotrope.

According to any of the foregoing embodiments, also disclosed herein are compositions wherein the fluoroethane (HFC-161) is present in an amount between 1 weight percent and 20 weight percent based on the total refrigerant composition.

According to any of the foregoing embodiments, also disclosed herein are compositions wherein the fluoroethane (HFC-161) is present in an amount between 1 weight percent and 15 weight percent based on the total refrigerant composition.

According to any of the foregoing embodiments, also disclosed herein are compositions wherein the fluoroethane (HFC-161) is present in an amount between 1 weight percent and 10 weight percent based on the total refrigerant composition.

According to any of the foregoing embodiments, also disclosed herein are compositions wherein the fluoroethane (HFC-161) is present in an amount between 1 weight percent and 7.5 weight percent based on the total refrigerant composition.

According to any of the foregoing embodiments, also disclosed herein are compositions wherein the fluoroethane (HFC-161) is present in an amount between 1 weight percent and 5 weight percent based on the total refrigerant composition.

According to any of the foregoing embodiments, also disclosed herein are compositions wherein the fluoroethane (HFC-161) is present in an amount between 4 weight percent and 6 weight percent based on the total refrigerant composition.

According to any of the foregoing embodiments, also disclosed herein are compositions wherein the heat capacity of the refrigerant composition is between 0.9% and 10.8% greater than the heat capacity of 2,3,3,3-tetrafluoropropene (HFO-1234yf) alone.

According to any of the foregoing embodiments, also disclosed herein are compositions wherein the heat capacity of the refrigerant composition is between 0.7% and 6.9% greater than the heat capacity of 2,3,3,3-tetrafluoropropene (HFO-1234yf) alone.

According to any of the foregoing embodiments, also disclosed herein are compositions wherein the refrigerant composition is a heat pump fluid.

According to any of the foregoing embodiments, also disclosed herein are compositions wherein the GWP of the refrigerant composition is less than 10.

According to any of the foregoing embodiments, also disclosed herein are compositions wherein the refrigerant composition has a temperature glide of less than or equal to 0.5 Kelvin (K) at temperatures of −30° C. up to 10° C.

According to any of the foregoing embodiments, also disclosed herein are compositions wherein the refrigerant composition has a temperature glide of less than or equal to 0.1 Kelvin (K) at temperatures of −30° C. up to 10° C.

According to any of the foregoing embodiments, also disclosed herein are compositions wherein the refrigerant composition has a temperature glide of less than or equal to 0.1 Kelvin (K) at temperatures of 20° C. up to 40° C.

According to any of the foregoing embodiments, also disclosed herein are compositions wherein the refrigerant composition has a temperature glide of less than or equal to 0.05 Kelvin (K) at temperatures of 20° C. up to 40° C.

According to any of the foregoing embodiments, also disclosed herein are compositions further comprising at least one additional compound:
a) comprising at least one member selected from the group consisting of 244bb, 245cb, 254eb, 1234ze, 12, 124, TFPY, 1140, 1225ye, 1225zc, 134a, 1243zf, and 1131,
b) comprising at least one member selected from the group consisting of ethylene, hexafluoropropylene (HFP), 3,3,3-trifluoropropyne,(TFPY), diethyl ether, ethyl chloride, ethyl ether, acetone, ethane, butane, isobutane, and CO2; and
c) combinations of a) and b);

wherein the total amount of the additional compound comprises greater than 0 and less than 1 wt % of the composition.

According to any of the foregoing embodiments, also disclosed herein are compositions further comprising at least one additional compound:
a) comprising at least one member selected from the group consisting of 134, 23, 125, 143a, 134a, 1234ze, 1243zf, 245fa, 1131, 1122, 244bb, 245cb, 1233xf, 1224, 1132a, 1131a, 12, and HFP,
b) comprising at least one member selected from the group consisting of ethylene, HFP, TFPY, diethyl ether, ethyl chloride, ethyl ether, acetone, ethane, butane, isobutane, and CO2; and,
c) combinations of a) and b);

wherein the total amount of the additional compound comprises greater than 0 and less than 1 wt % of the composition.

According to any of the foregoing embodiments, also disclosed herein are compositions further comprising at least one additional compound:
a) comprising at least one member selected from the group consisting of methane, ethane, 143a, 1234ze, ethylene oxide, 1123, 1243zf, propane, 23, 263fb, 124, 254eb, 1224yd,
b) comprising at least one member selected from the group consisting of ethylene, HFP, TFPY, diethyl ether, ethyl chloride, ethyl ether, acetone, ethane, butane, isobutane, and CO2; and,
c) combinations of a) and b);

wherein the amount of the additional compound comprises greater than 0 and less than 1 wt % of the composition.

According to any of the foregoing embodiments, also disclosed herein are wherein the additional compound comprises (a).

According to any of the foregoing embodiments, also disclosed herein are wherein the additional compound comprises (b).

According to any of the foregoing embodiments, also disclosed herein are wherein the additional compound comprises (c).

According to any of the foregoing embodiments, also disclosed herein are compositions further comprising a POE (polyolester) lubricant.

According to any of the foregoing embodiments, also disclosed herein are compositions further comprising a POE lubricant and wherein the composition has a TAN, mg KOH/g number of less than about 1.

According to any of the foregoing embodiments, also disclosed herein is a refrigerant storage container comprising any combination of the foregoing compositions wherein the composition comprises gaseous and liquid phases and wherein the oxygen and water concentration in the gas and liquid phases ranges from about 3 vol ppm to less than about 3,00 vol ppm at a temperature of about 25C.

In another embodiment, disclosed herein a heating or cooling system comprising, in a serial arrangement: a condenser; an evaporator; and a compressor, the system further comprising each of the condenser, evaporator and compressor operably connected, the refrigerant composition of any of the foregoing embodiments being circulated through each of the condenser, evaporator and compressor.

According to any of the foregoing embodiments, also disclosed herein are heating or cooling systems wherein the system is an air conditioner for an automotive system.

According to any of the foregoing embodiments, also disclosed herein are heating or cooling systems wherein the system is an air conditioner for a stationary cooling system.

According to any of the foregoing embodiments, also disclosed herein are heating or cooling systems further comprising a 4-way valve.

According to any of the foregoing embodiments, also disclosed herein are heating or cooling systems wherein the system is a heat pump for an automotive system.

According to any of the foregoing embodiments, also disclosed herein are heating or cooling systems wherein the system is heat pump for a residential heating or cooling system.

According to any of the foregoing embodiments, also disclosed herein are heating or cooling systems wherein a temperature glide is less than 1.1 Kelvin (K).

According to any of the foregoing embodiments, also disclosed herein are methods for heating or cooling a passenger compartment of an HEV, MHEV, PHEV, or EV using combinations of the systems disclosed herein and a refrigerant comprising any combination of the foregoing compositions.

According to any of the foregoing embodiments, also disclosed herein is the use of the refrigerant composition of any of the foregoing embodiments in a heat pump system.

According to any of the foregoing embodiments, also disclosed herein is the use of the refrigerant composition of any of the foregoing embodiments in an HEV, MHEV, PHEV, or EV heat pump system.

According to any of the foregoing embodiments, also disclosed herein is the use of the refrigerant composition of any of the foregoing embodiments in an HEV, MHEV, PHEV, or EV heat pump system in combination with a vehicle electrical system.

According to any of the foregoing embodiments, also disclosed herein is a method of charging a refrigerant composition to an automotive system that includes providing the composition of any of the foregoing embodiments to an automotive heating or cooling system.

In another embodiment, disclosed herein a method for improving (removing) gross contaminants from a refrigerant composition comprising any of the foregoing embodiments comprising: providing a first refrigerant composition; wherein the first refrigerant composition is not near azeotropic and includes 2,3,3,3-tetrafluoropropene (HFO-1234yf) and fluoroethane (HFC-161); providing at least one of 2,3,3,3-tetrafluoropropene (HFO-1234yf) or fluoroethane (HFC-161) to the first refrigerant composition to form a second refrigerant composition; wherein the second refrigerant composition is near-azeotropic.

According to any of the foregoing embodiments, also disclosed herein is a method wherein the second refrigerant composition is formed from the first refrigerant composition without the use of conventional onsite automatic recovery, recycle, recharge equipment.

According to any of the foregoing embodiments, also disclosed is are compositions wherein the composition has a flammability rating of 2 L (when measured in accordance with ANSI/ASHRAE Standard 34 or ISO 817), a Burning Velocity (BV) of less than 10 cm/sec (when measured in accordance of ISO 817 vertical tube method), and a Lower Flammability Level (LFL) of less than 10 vol % (when measured in accordance with ASTM E681).

According to any of the foregoing embodiments, also disclosed are compositions wherein the composition has a flammability rating of 2 L when further comprising up to 5 wt % of perfluoropolyether lubricant.

The various aspects and embodiments of the invention can be used alone or in combinations with each other. Other features and advantages of the present invention will be apparent from the following more detailed description of the preferred embodiment which illustrates, by way of example, the principles of the invention.

### BRIEF DESCRIPTION OF THE DRAWINGS

FIG. 1 illustrates the vapor/liquid equilibrium properties of blends of HFO-1234yf and HFC-161, according to an embodiment.

FIG. 2 illustrates the vapor/liquid equilibrium properties of blends of HFO-1234yf and HFC-161, according to an embodiment.

FIG. 3 illustrates the temperature glide of blends of HFO-1234yf and HFC-161, according to an embodiment.

FIG. 4 illustrates the temperature glide of blends of HFO-1234yf and HFC-161, according to an embodiment.

FIG. 5 illustrates the properties of blends of HFO-1234yf and HFC-161, according to an embodiment.

FIG. 6 illustrates a reversible cooling or heating loop system, according to an embodiment.

FIG. 7 illustrates a reversible cooling or heating loop system according to an embodiment.

FIG. 8 illustrates reversible cooling or heating loop system, according to an embodiment.

FIG. 9 illustrates reversible cooling or heating loop system, according to an embodiment.

FIG. 10 illustrates the vapor / liquid equilibrium properties of blends of HFO-1234yf and HFC-161, according to an embodiment.

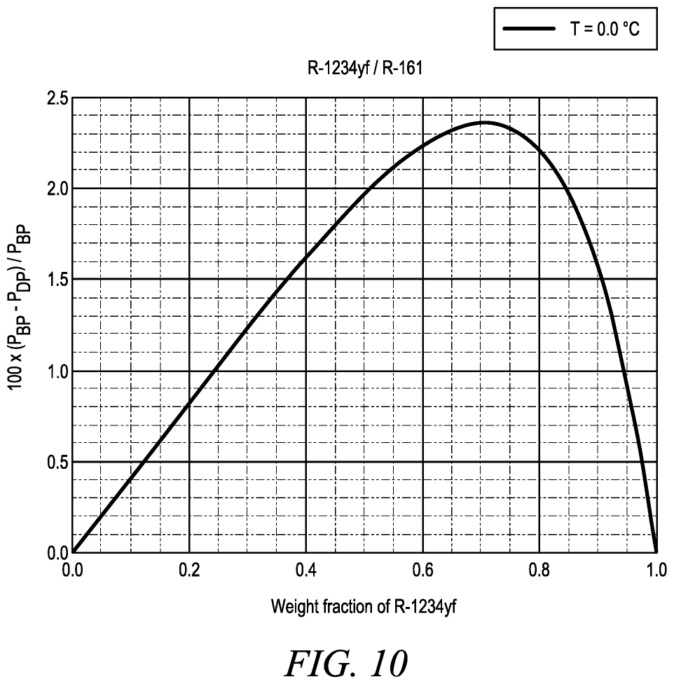

FIG. 11 illustrates the vapor / liquid equilibrium properties of blends of HFO-1234yf and HFC-161, according to an embodiment.

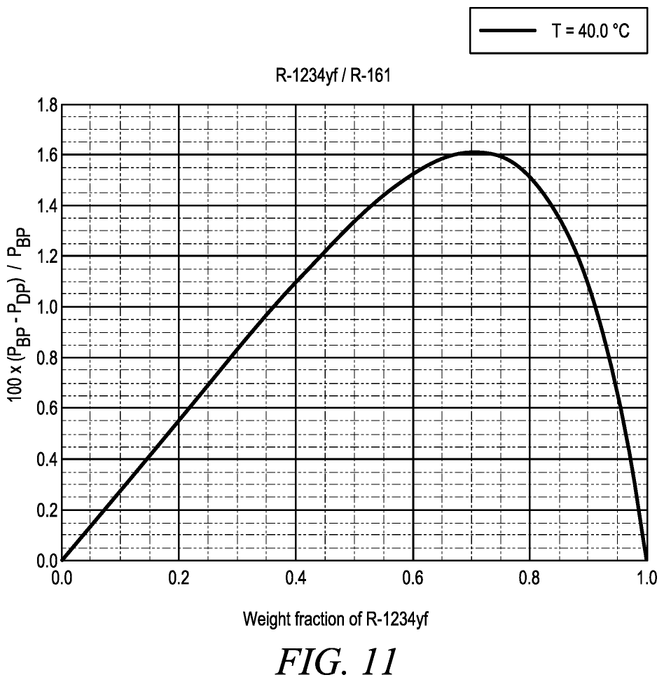

### DETAILED DESCRIPTION

### Definitions

As used herein, the term heat transfer composition means a composition used to carry heat from a heat source to a heat sink.

A heat source is defined as any space, location, object or body from which it is desirable to add, transfer, move or remove heat. Example of a heat source in this embodiment is the vehicle passenger compartment requiring air conditioning.

A heat sink is defined as any space, location, object or body capable of absorbing heat. Example of a heat sink in this embodiment is the vehicle passenger compartment requiring heating.

A heat transfer system is the system (or apparatus) used to produce a heating or cooling effect in a particular location. A heat transfer system in this invention implies the reversible heating or cooling system which provides heating or cooling of the passenger cabin. Sometimes this system is called a heat pump system, reversible heating loop, or reversible cooling loop.

A heat transfer fluid comprises at least one refrigerant and at least one member selected from the group consisting of lubricants, stabilizers and flame suppressants.

Refrigeration capacity (also referred to as cooling capacity) is a term which defines the change in enthalpy of a refrigerant in an evaporator per pound of refrigerant circulated, or the heat removed by the refrigerant in the evaporator per unit volume of refrigerant vapor exiting the evaporator (volumetric capacity). The refrigeration capacity is a measure of the ability of a refrigerant or heat transfer composition to produce cooling or heating Therefore, the higher the capacity, the greater the cooling or heating that is produced. Cooling rate refers to the heat removed by the refrigerant in the evaporator per unit time. Heating rate refers to the heat removed by the refrigerant in the evaporator per unit time.

Coefficient of performance (COP) is the amount of heat removed divided by the required energy input to operate the cycle. The higher the COP, the higher is the energy efficiency. COP is directly related to the energy efficiency ratio (EER) that is the efficiency rating for refrigeration or air conditioning equipment at a specific set of internal and external temperatures. Subcooling refers to the reduction of the temperature of a liquid below that liquid's saturation point for a given pressure. The liquid saturation point is the temperature at which the vapor is completely condensed to a liquid. Subcooling continues to cool the liquid to a lower temperature liquid at the given pressure. By cooling a liquid below the saturation temperature (or bubble point temperature), the net refrigeration capacity can be increased. Subcooling thereby improves refrigeration capacity and energy efficiency of a system. The subcool amount is the amount of cooling below the saturation temperature (in degrees).

Superheating refers to the increase of the temperature of a vapor above that vapor's saturation point for a given pressure. The vapor saturation point is the temperature at which the liquid is completely evaporated to a vapor. Superheating continues to heat the vapor to a lower temperature liquid at the given pressure. By heating the vapor above the saturation temperature (or dew point temperature), the net refrigeration capacity can be increased. Superheating thereby improves refrigeration capacity and energy efficiency of a system. The superheat amount is the amount of heating above the saturation temperature (in degrees).

Temperature glide (sometimes referred to simply as “glide”) is the absolute value of the difference between the starting and ending temperatures of a phase-change process by a refrigerant within a component of a refrigerant system, exclusive of any subcooling or superheating. This term may be used to describe condensation or evaporation of a near azeotrope or non-azeotropic composition. When referring to the temperature glide of an air conditioning or heat pump system, it is common to provide the average temperature glide being the average of the temperature glide in the evaporator and the temperature glide in the condenser. Glide is applicable to blend refrigerants, i.e. refrigerants that are composed of at least 2 components.

Low glide here is defined as average glide which is less than 3K over operating range of interested, more preferably low glide is less than 2.5K over operating range of interest with most preferable being less than 0.75K over operating range of interest (e.g., a glide ranging from great than 0 to less than about 0.75K).

By azeotropic composition is meant a constant-boiling mixture of two or more substances that behave as a single substance. One way to characterize an azeotropic composition is that the vapor produced by partial evaporation or distillation of the liquid has the same composition as the liquid from which it is evaporated or distilled, i.e., the mixture distills/refluxes without compositional change. Constant-boiling compositions are characterized as azeotropic because they exhibit either a maximum or minimum boiling point, as compared with that of the non-azeotropic mixture of the same compounds. An azeotropic composition will not fractionate within an air conditioning or heating system during operation. Additionally, an azeotropic composition will not fractionate upon leakage from an air conditioning or heating system.

A near-azeotropic composition (also commonly referred to as an “azeotrope-like composition”) is a substantially constant boiling liquid admixture of two or more substances that behaves essentially as a single substance. One way to characterize a near-azeotropic composition is that the vapor produced by partial evaporation or distillation of the liquid has substantially the same composition as the liquid from which it was evaporated or distilled, that is, the admixture distills/refluxes without substantial composition change. Another way to characterize a near-azeotropic composition is that the bubble point vapor pressure and the dew point vapor pressure of the composition at a particular temperature are substantially the same. Herein, a composition is near-azeotropic if, after 50 weight percent of the composition is removed, such as by evaporation or boiling off, the difference in vapor pressure between the original composition and the composition remaining after 50 weight percent of the original composition has been removed is less than about 10 percent.

Near-azeotropic compositions exhibit dew point pressure and bubble point pressure with virtually no pressure differential. That is, the difference in the dew point pressure and bubble point pressure at a given temperature will be a small value. It may be stated that compositions with a difference in dew point pressure and bubble point pressure of less than or equal to 3 percent (based upon the bubble point pressure) may be considered to be a near-azeotropic.

It is also recognized that both the boiling point and the weight percentages of each component of the azeotropic or near-azeotropic liquid composition may change when the azeotropic or near-azeotropic liquid composition is subjected to boiling at different pressures. Thus, an azeotropic or a near-azeotropic composition may be defined in terms of the unique relationship that exists among the components or in terms of the compositional ranges of the components or in terms of exact weight percentages of each component of the composition characterized by a fixed boiling point at a specified pressure. It is also recognized in the art that various azeotropic compositions (including their boiling points at particular pressures) may be calculated (see, e.g., W. Schotte Ind. Eng. Chem. Process Des. Dev. (1980) 19, 432-439; the disclosure of which is incorporated by reference). Experimental identification of azeotropic compositions involving the same components may be used to confirm the accuracy of such calculations and/or to modify the calculations at the same or other temperatures and pressures.

As used herein, the terms “comprises,” “comprising,” “includes,” “including,” “has,” “having” or any other variation thereof, are intended to cover a non-exclusive inclusion. For example, a composition, process, method, article, or apparatus that comprises a list of elements is not necessarily limited to only those elements but may include other elements not expressly listed or inherent to such composition, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The transitional phrase “consisting of” excludes any element, step, or ingredient not specified. If in the claim such would close the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” is used to define a composition, method that includes materials, steps, features, components, or elements, in addition to those literally disclosed provided that these additional included materials, steps, features, components, or elements do materially affect the basic and novel characteristic(s) of the claimed invention, especially the mode of action to achieve the desired result of any of the processes of the present invention. The term ‘consisting essentially of’ occupies a middle ground between “comprising” and ‘consisting of’.

Where applicants have defined an invention or a portion thereof with an open-ended term such as “comprising,” it should be readily understood that (unless otherwise stated) the description should be interpreted to also include such an invention using the terms “consisting essentially of” or “consisting of” including, for example, a composition consisting essentially of or consisting of.

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

### REFRIGERANT BLEND (Class A2, GWP<10 and 0 ODP)

Global warming potential (GWP) is an index for estimating relative global warming contribution due to atmospheric emission of a kilogram of a particular greenhouse gas compared to emission of a kilogram of carbon dioxide. GWP can be calculated for different time horizons showing the effect of atmospheric lifetime for a given gas. The GWP for the 100-year time horizon is commonly the value referenced. For mixtures, a weighted average can be calculated based on the individual GWPs for each component. The United Nations Intergovernmental Panel on Climate Control (IPCC) provides vetted values for refrigerant GWPs in official assessment reports (ARs.) The fourth assessment report is denoted as AR4 and the fifth assessment report is denoted as AR5. Regulating bodes are currently using AR4 for official legislating purposes.

Ozone-depletion potential (ODP) is a number that refers to the amount of ozone depletion caused by a substance. The ODP is the ratio of the impact on ozone of a chemical compared to the impact of a similar mass of R-11 or fluorotrichloromethane. R-11 is a type of chlorofluorocarbon (CFC) and as such has chlorine in it which contributes to ozone depletion. Furthermore, the ODP of CFC-11 is defined to be 1.0. Other CFCs and hydrofluorochlorocarbons (HCFCs) have ODPs that range from 0.01 to 1.0. Hydrofluorocarbons (HFCs) and the hydrofluoro-olefins (HFO's) described herein have zero ODP because they do not contain chlorine, bromine or iodine, species known to contribute to ozone breakdown and depletion. Hydrofluorocarbons (HFC's) also do not have ODP as they by definition also do not contain chlorine, bromine or iodine.

The refrigerant blend compositions comprise at least one hydrofluoro-olefin such as 2,3,3,3-tetrafluoropropene (HFO-1234yf) and at least one hydrofluorocarbon such as fluoroethane (HFC-161). Suitable amounts of fluoroethane (HFC-161) in the refrigerant blend include, but are not limited to an amount between about 1 weight percent and 20 weight percent or between about 1 weight percent and 15 weight percent or between about 1 weight percent and 10 weight percent or between about 1 weight percent and 7.5 weight percent or between about 1 weight percent and 5 weight percent or between about 4 weight percent and 6 weight percent based on the total refrigerant composition.

The unsaturated hydrofluoro-olefin (HFO) refrigerant components also have very low GWP, with all HFO components having GWP<10. The hydrofluorocarbon (HFC) refrigerant component includes fluoroethane (HFC-161). The HFC component also have very low GWP, with the fluoroethane (HFC-161) having a GWP of 12.

Therefore, the final blends have 0 ODP and ultra-low GWP, or GWP<10. Table 1, shown below, is a summary table showing type, ODP and GWP per the 4^{th} and the 5^{th} assessment conducted by the Intergovernmental Panel on Climate Control (IPCC) for 2,3,3,3-tetrafluoropropene (HFO-1234yf), fluoroethane (HFC-161), and various combinations thereof. The inventive refrigerant blends can have a GWP ranging from greater than 0 to less than about 10, greater than 0 to less than about 6 and in some cases greater than 0 to less than about 5.

For the blend, GWP may be calculated as a weighted average of the individual GWP values in the blend, taking into account the amount (e.g., weight %) of each ingredient (1−n) in the blend, as shown in Equation (1) below.

GWP Blend=Amount1(GWP of component 1)+Amount2(GWP component 2)+ . . . Amount n(GWP of component n) (1)

TABLE 1

| | | GWP AR4 |
|---|---|---|
| Refrigerant | Refrigerant Type | (IPCC) |
| HFO-1234yf | HFO | 4 |
| HFC-161 | HFC | 12 |
| HFO-1234yf (99%)/HFC-161 (1%) | HFO/HFC | 4.1 |
| HFO-1234yf (95%)/HFC-161 (5%) | HFO/HFC | 4.4 |
| HFO-1234yf (92.5%)/HFC-161 (7.5%) | HFO/HFC | 4.6 |
| HFO-1234yf (90%)/HFC-161 (10%) | HFO/HFC | 4.8 |
| HFO-1234yf (85%)/HFC-161 (15%) | HFO/HFC | 5.2 |
| HFO-1234yf (80%)/HFC-161 (20%) | HFO/HFC | 5.6 |

### REFRIGERANT LUBRICANT

The refrigerant or heat transfer compositions of the present invention can be mixed with a lubricant and used as a “complete working fluid composition” of the present invention. The refrigerant composition of the present invention containing the heat transfer or working fluid of the present invention and the lubricant may contain additives such as a stabilizer, a leakage detection material and other beneficial additives. It is also possible for the lubricant to impact the flammability level of the resulting compound.

The lubricant chosen for this composition preferably has sufficient solubility in the vehicle's A/C refrigerant to ensure that the lubricant can return to the compressor from the evaporator. Furthermore, the lubricant preferably has a relatively low viscosity at low temperatures so that the lubricant is able to pass through the cold evaporator. In one preferred embodiment, the lubricant and A/C refrigerant are miscible over a broad range of temperatures.

Preferred lubricants may be one or more polyol ester type lubricants. (POEs). Polyol ester as used herein include compounds containing an ester of a diol or a polyol having from about 3 to 20 hydroxyl groups and a fatty acid having from about 1 to 24 carbon atoms is preferably used as the polyol. An ester which can be used as the base oil. (EUROPEAN PATENT APPLICATION published in accordance with Art. 153(4) EP 2 727 980 A1, which is hereby incorporated by reference). Here, examples of the diol include ethylene glycol, 1,3-propanediol, fluoroethane glycol, 1,4-butanediol, 1,2-butanediol, 2-methyl-1,3-propanediol, 1,5-pentanediol, neopentyl glycol, 1,6-hexanediol, 2-ethyl-2-methyl-1,3-propanediol, 1,7-heptanediol, 2-methyl-2-propyl-1,3-propanediol, 2,2-diethyl-1,3-propanediol, 1,8-octanediol, 1,9-nonanediol, 1,10-decanediol, 1,11-undecanediol, 1,12-dodecanediol, and the like.

Examples of the above-described polyol include a polyhydric alcohol such as trimethylolethane, trimethylolpropane, trimethylolbutane, di(trimethylolpropane), tri(trimethylolpropane), pentaerythritol, di(pentaerythritol), tri(pentaerythritol), glycerin, polyglycerin (dimer to eicosamer of glycerin), 1,3,5-pentanetriol, sorbitol, sorbitan, a sorbitol-glycerin condensate, adonitol, arabitol, xylitol, mannitol, etc.; a saccharide such as xylose, arabinose, ribose, rhamnose, glucose, fructose, galactose, mannose, sorbose, cellobiose, maltose, isomaltose, trehalose, sucrose, raffinose, gentianose, melezitose, among others; partially etherified products and methyl glucosides thereof; and the like. Among these, a hindered alcohol such as neopentyl glycol, trimethylolethane, trimethylolpropane, trimethylolbutane, di(trimethylolpropane), tri(trimethylolpropane), pentaerythritol, di(pentaerythritol), tri(pentaerythritol), etc. is preferable as the polyol.

Though the fatty acid is not particularly limited on its carbon number, in general, a fatty acid having from 1 to 24 carbon atoms is used. In the fatty acid having from 1 to 24 carbon atoms, a fatty acid having 3 or more carbon atoms is preferable, a fatty acid having 4 or more carbon atoms is more preferable, a fatty acid having 5 or more carbon atoms is still more preferable, and a fatty acid having 10 or more carbon atoms is the most preferable from the standpoint of lubricating properties. In addition, a fatty acid having not more than 18 carbon atoms is preferable, a fatty acid having not more than 12 carbon atoms is more preferable, and a fatty acid having not more than 9 carbon atoms is still more preferable from the standpoint of compatibility with the refrigerant.

In addition, the fatty acid may be either of a linear fatty acid and a branched fatty acid, and the fatty acid is preferably a linear fatty acid from the standpoint of lubricating properties, whereas it is preferably a branched fatty acid from the standpoint of hydrolysis stability. Furthermore, the fatty acid may be either of a saturated fatty acid and an unsaturated fatty acid. Specifically, examples of the above-described fatty acid include a linear or branched fatty acid such as pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, nonadecanoic acid, icosanoic acid, oleic acid, etc.; a so-called neo acid in which a carboxylic group is attached to a quaternary carbon atom; and the like. More specifically, preferred examples thereof include valeric acid (n-pentanoic acid), caproic acid (n-hexanoicacid), enanthic acid (n-heptanoic acid), caprylic acid (n-octanoic acid), pelargonic acid (n-nonanoic acid), capric acid (n-decanoic acid), oleic acid (cis-9-octadecenoic acid), isopentanoic acid (3-methylbutanoic acid), 2-methylhexanoic acid,2-ethylpentanoic acid, 2-ethylhexanoic acid, 3,5,5-trimethylhexanoic acid, and the like. Incidentally, the polyol ester maybe a partial ester in which the hydroxyl groups of the polyol remain without being fully esterified; a complete ester in which all of the hydroxyl groups are esterified; or a mixture of a partial ester and a complete ester, with a complete ester being preferable.

In the polyol ester, an ester of a hindered alcohol such as neopentyl glycol, trimethylolethane, trimethylolpropane, trimethylolbutane, di(trimethylolpropane), tri(trimethylolpropane), pentaerythritol, di(pentaerythritol), tri(pentaerythritol), etc. is more preferable, with an ester of neopentyl glycol, trimethylolethane, trimethylolpropane, trimethylolbutane, or pentaerythritol being still more preferable, from the standpoint of more excellent hydrolysis stability; and an ester of pentaerythritol is the most preferable from the standpoint of especially excellent compatibility with the refrigerant and hydrolysis stability.

Preferred specific examples of the polyol ester include a diester of neopentyl glycol with one kind or two or more kinds of fatty acids selected from valeric acid, caproic acid, enanthic acid, caprylic acid, pelargonic acid, capric acid, oleic acid, isopentanoic acid, 2-methylhexanoic acid, 2-ethylpentanoic acid, 2-ethylhexanoic acid, and 3,5,5-trimethylhexanoic acid; a triester of trimethylolethane with one kind or two or more kinds of fatty acids selected from valeric acid, caproic acid, enanthic acid, caprylic acid, pelargonic acid, capric acid, oleic acid, isopentanoic acid, 2-methylhexanoic acid, 2-ethylpentanoic acid, 2-ethylhexanoic acid, and 3,5,5-trimethylhexanoic acid; a triester of trimethylolpropane with one kind or two or more kinds of fatty acids selected from valeric acid, caproic acid, enanthic acid, caprylic acid, pelargonic acid, capric acid, oleic acid, isopentanoic acid, 2-methylhexanoic acid, 2-ethylpentanoic acid, 2-ethylhexanoic acid, and 3, 5, 5-trimethylhexanoic acid; a triester of trimethylolbutane with one kind or two or more kinds of fatty acids selected from valeric acid, caproic acid, enanthic acid, caprylic acid, pelargonic acid, capric acid, oleic acid, isopentanoic acid, 2-methylhexanoic acid, 2-ethylpentanoic acid, 2-ethylhexanoic acid, and 3,5,5-trimethylhexanoic acid; and a tetraester of pentaerythritol with one kind or two or more kinds of fatty acids selected from valeric acid, caproic acid, enanthic acid, caprylic acid, pelargonic acid, capric acid, oleic acid, isopentanoic acid, 2-methylhexanoic acid, 2-ethylpentanoic acid, 2-ethylhexanoic acid, and 3,5,5-trimethylhexanoic acid. Incidentally, the ester with two or more kinds of fatty acids may be a mixture of two or more kinds of esters of one kind of a fatty acid and a polyol, and an ester of a mixed fatty acid of two or more kinds thereof and a polyol, particularly an ester of a mixed fatty acid and a polyol is excellent in low-temperature properties and compatibility with the refrigerant.

In a preferred embodiment, the lubricant is soluble in the refrigerant at temperatures between about −35° C. and about 100° C., and more preferably in the range of about −30° C. and about 40° C., and even more specifically between −25° C. and 40° C. In another embodiment, attempting to maintain the lubricant in the compressor is not a priority and thus high temperature insolubility is not preferred.

The lubricant used for electrified automotive air-conditioning application may have a kinematic viscosity (measured at 40° C., according to ASTM D445) between 75-110 cSt, and ideally about 80 cSt-100 cSt and most specifically, between 85cSt-95cSt. However, not wanting to limit the invention, it should be noted that other lubricant viscosities may be used depending on the needs of the electrified vehicle A/C compressor, heat pump or other thermal management systems.

The amount of lubricant can range from about 1 wt % to about 20 wt % about 1 wt % to about 7 wt % and, in some cases, about 1 wt % to about 3 wt %.

To suppress the hydrolysis of the lubricating oil, it is necessary to control the moisture concentration in the heating/cooling system for electric type vehicles. Therefore, the lubricant in this embodiment needs to have low moisture, typically less than 100 ppm by weight.

In a preferred embodiment, the lubricant comprises a POE lubricant that is soluble in the vehicle A/C system refrigerant at temperatures between about −35° C. and about 100° C., and more preferably in the range of about −35° C. and about 50° C., and even more specifically between −30° C. and 40° C. In another preferred embodiment, the POE lubricant is soluble at temperatures above about 70° C., more preferably at temperatures above about 80° C., and most preferably at temperatures between 90 -95° C.

The POE lubricant used for electrified automotive air-conditioning application may have a kinematic viscosity (measured at 40° C., according to ASTM D445) between 75-110 cSt, and ideally about 80 cSt-100 cSt and most specifically, between 85 cst-95 cSt. However, not wanting to limit the invention, it should be noted that other lubricant viscosities may be included depending on the needs of the electrified vehicle A/C compressor. Suitable characteristics of an automotive POE type lubricant for use with the inventive composition are listed below.

| Specification Item | Units | Method | POE Properties | |
|---|---|---|---|---|
| Viscosity at 40° C. | cSt | ASTM D445 | 80-90 | |
| Viscosity at 100° C. | cSt | ASTM D445 | 9.0-9.3 | |
| Viscosity Index | | ASTM D2270 | >80 | |
| Colour | Gardner | ASTM D1500 | <1 | |
| Flash point (COC) | ° C. | ASTM 92 | 250 | min |
| Pour point | ° C. | ASTM D97 | −40 | max |
| Specific Gravity (20° C.) | Kg/m3 | ASTM D1298 | 0.950-1.10 | |
| Capping Efficiency | % | ASTM E326 | 80-90 | |
| Total Acid Number | mgKOH/g | ASTM D974 | 0.1 | max |
| Water content | ppm | ASTM E284 | 50 | max |

In one embodiment, the lubricant comprises POE and the POE is stable when exposed to the inventive compositions wherein the refrigeration composition has an F-ion of less than about 500 ppm and in some cases an F-ion amount of greater than 0 and less than 500 ppm, greater than 0 and less than 100 ppm and, in some cases, greater than 0 and less than 50 ppm. In an aspect of this embodiment, the refrigerant comprises 1234yf and about 1 to about 10 wt. % 161 and, in a further aspect, the refrigerant composition further comprises greater than about 0 and less than 1 wt. % of additional compounds.

In one embodiment, the lubricant comprises POE is stable when exposed to the inventive composition wherein the refrigeration composition has a Total Acid Number (TAN), mg KOH/g number of less than about 1, greater than 0 and less than 1, greater than 0 and less than about 0.75 and, in some cases, greater than 0 and less than about 0.4. In an aspect of this embodiment, the lubricant comprises POE and the refrigerant comprises 1234yf and about 1 to about 10 wt. % 161 and, in a further aspect, the refrigerant composition further comprises greater than about 0 and less than 1 wt. % of additional compounds.

### REFRIGERANT STABILIZERS

HFO type refrigerants, due to the presence of a double bond, may be subject to thermal instability and decompose under extreme use, handling or storage situations. Therefore, there may be advantages to adding stabilizers to HFO type refrigerants. Stabilizers may notably include nitromethane, ascorbic acid, terephthalic acid, azoles such as tolutriazole or benzotriazole, phenolic compounds such as tocopherol, hydroquinone, t-butyl hydroquinone, 2,6-di-tertbutyl-4-methylphenol, epoxides (possibly fluorated or perfluorated alkyl epoxides or alkenyl or aromatic epoxides) such as n-butyl glycidyl ether, hexanediol diglycidyl ether, allyl glycidyl ether, butylphenylglycidyl ether, cyclic monoterpenes, terpenes, such as d-limonene or alpha and beta-pinene, phosphites, phosphates, phosphonates, thiols and lactones. Examples of suitable stabilizers are disclosed in WO2019213004, WO2020222864, and WO2020222865; the disclosures of which are hereby incorporated by reference.

Blends may or may not include stabilizers depending on the requirements of the system being used. If the refrigerant blend does include a stabilizer, it may include any amount from 0.001 wt % up to 1 wt % of any of the stabilizers listed above, and, in most case, preferably d-limonene.

### REFRIGERANT BLEND FLAMMABILITY

Flammability is a term used to mean the ability of a composition to ignite and/or propagate a flame. For refrigerants and other heat transfer compositions or working fluids, the lower flammability limit (“LFL”) is the minimum concentration of the heat transfer composition in air that is capable of propagating a flame through a homogeneous mixture of the composition and air under test conditions specified in ASTM (American Society of Testing and Materials) E681. The upper flammability limit (“UFL”) is the maximum concentration of the heat transfer composition in air that is capable of propagating a flame through a homogeneous mixture of the composition and air under the same test conditions.

In order to be classified by ANSI/ASHRAE (American Society of Heating, Refrigerating and Air-Conditioning Engineers) Standard 34 or ISO 817 ISO 817:2014(en) Refrigerants—Designation and Safety Classification as non-flammable (class 1, no flame propagation), a refrigerant must meet the conditions of ASTM E681 as formulated in both the liquid and vapor phase as well as non-flammable in both the liquid and vapor phases that result during leakage scenarios defined by ANSI/ASHRAE standard 34: 2019 or ISO 817:2014(en) Refrigerants—Designation and Safety Classification.

In order for a refrigerant to be classified by ANSI/ASHRAE (American Society of Heating, Refrigerating and Air-Conditioning Engineers) as low flammability (class 2L), the refrigerant: 1) exhibits flame propagation when tested at 140° F. (60° C.) and 14.7 psia (101.3 kPa), 2) has an LFL >0.0062 lb/ft³ (0.10 kg/m3), 3) a maximum burning velocity of ≤3.9 in./s (10 cm/s) when tested at 73.4° F. (23.0° C.) and 14.7 psia (101.3 kPa). and 4) has a heat of combustion <8169 Btu/lb (19,000 kJ/kg). 2,3,3,3-tetrafluoropropene (HFO-1234yf).

In order for a refrigerant to be classified by ANSI/ASHRAE Standard 34 class 2, the refrigerant 1) exhibits flame propagation when tested at 140° F. (60° C.) and 14.7 psia (101.3 kPa), 2) has an LFL >0.0062 lb/ft³ (0.10 kg/m³) and 3) has a heat of combustion <8169 Btu/lb (19,000 kJ/kg). Fluoroethane (HFC-161) appears to have ANSI/ASHRAE standard 34 class 2 flammability rating based on literature and tested LFL values.

In order for a refrigerant to be classified by ANSI/ASHRAE standard 34 class 3, refrigerant 1) exhibits flame propagation when tested at 140° F. (60° C.) and 14.7 psia (101.3 kPa), 2) has an LFL <0.0062 lb/ft³ (0.10 kg/m³) or 3) has a heat of combustion >8169 Btu/lb (19,000 kJ/kg). Generally, most hydrocarbons are ANSI/ASHRAE standard 34 class 3 flammability When the HFO component and the HFC components are blended together in the correct proportions, the resulting blend has class 2 flammability as defined by ANSI/ASHRAE standard 34 and ISO 817. Class 2 flammability is inherently less flammable (i.e., lower energy release as exemplified by the Heat of Combustion or HOC value) than class 3 flammability and can be managed in automotive heating/cooling systems. ASHRAE Standard 34 provides a methodology to calculate the heat of combustion for refrigerant blends using a balanced stoichiometric equation based on the complete combustion of one mole of refrigerant with enough oxygen for a stoichiometric reaction.

When the HFO component and the HFC components are blended together in a different proportion, the resulting blend has class 2L flammability as defined by ANSI/ASHRAE standard 34 and ISO 817. Class 2L flammability is inherently less flammable (i.e., lower energy release as exemplified by the Heat of Combustion or HOC value) than both class 2 and class 3 flammability and can be managed in automotive heating/cooling systems. ASHRAE Standard 34 provides a methodology to calculate the heat of combustion for refrigerant blends using a balanced stoichiometric equation based on the complete combustion of one mole of refrigerant with enough oxygen for a stoichiometric reaction.

The inventive blends can have a flammability rating of 2L (when measured in accordance with ANSI/ASHRAE standard 34 definition for class 2L: a BV of less than 10 cm/sec (when measured in accordance of ANSI/ASHRAE standard 34 using the vertical tube method as presented in ISO 817 Appendix C), and an LFL of less than 10 vol % (when measured in accordance with ASTM E681:09 (2015)).

The toxicity of HFO-1234yf components has been reviewed by WEEL or similar toxicological type committee and found to have toxicity values greater than 400 ppm and therefore classified by ANSI/ASHRAE standard 34 and ISO 817 as class A or low toxicity level. Likewise, the toxicity of R-161 is expected to be low and should also be classified as class A.

In embodiments, the refrigerant blends include 2,3,3,3-tetrafluoropropene (HFO-1234yf) and fluoroethane (HFC-161). In some embodiments, the refrigerant blends may comprise, consist essentially of or consist of 2,3,3,3-tetrafluoropropene (HFO-1234yf) and fluoroethane (HFC-161). In some embodiments, the refrigerant blends may comprise, consist essentially of or consist of 10 to 99 weight percent, 20 to 99 weight percent, 30 to 99 weight percent, 40 to 99 weight percent, 50 to 99 weight percent, 60 to 99 weight percent, 70 to 99 weight percent 80 to 99 weight percent, 85 to 98 weight percent, 90 to 97 weight percent, 94 to 96 weight percent, about 95 weight percent, and combinations thereof of 2,3,3,3-tetrafluoropropene (HFO-1234yf) and 1 to 90 weight percent, 1 to 80 weight percent, 1 to 70 weight percent, 1 to 60 weight percent, 1 to 50 weight percent, 1 to 40 weight percent, 1 to 30 weight percent, 1 to 20 weight percent, 2 to 15 weight percent, 3 to 10 weight percent, 4 to 6 weight percent, about 5 weight percent, and combinations thereof of fluoroethane (HFC-161). In one embodiment, the refrigerant blend comprises about 95 weight percent 2,3,3,3-tetrafluoropropene (HFO-1234yf) and about 5 weight percent fluoroethane (HFC-161). In one embodiment, the refrigerant blend consists of about 95 weight percent 2,3,3,3-tetrafluoropropene (HFO-1234yf) and about 5 weight percent fluoroethane (HFC-161).

In one embodiment, any of the foregoing refrigerant compositions can further comprise at least one additional compound selected from the group consisting of 244bb, 245cb, 254eb, 1234ze, 12, 124, TFPY, 1140, 1225ye, 1225zc, 134a, 1243zf, 1131, ethylene, diethyl ether, ethyl ether, ethane, butane, isobutane, CO2, HFP, TFPY, ethyl chloride, and acetone,

In one embodiment, any of the foregoing refrigerant compositions can further comprise at least one additional compound selected from the group consisting of 134, 23, 125, 143a, 134a, 1234ze, 1243zf, 245fa, 1131, 1122, 244bb, 245cb, 245eb, 1233xf, 1224, 1132a, 1131a, 12, HFP, ethylene, diethyl ether, ethyl ether, ethane, butane, isobutane, CO2, HFP, TFPY, ethyl chloride, and acetone,

In one embodiment, any of the foregoing refrigerant compositions can further comprise at least one additional compound selected from the group consisting of methane, ethane, 143a, 1234ze, ethylene oxide, 1123, 1243zf, propane, 23, 263fb, 124, 254eb, 1224yd, ethylene, diethyl ether, ethyl ether, ethane, butane, isobutane, CO2, HFP, TFPY, ethyl chloride and acetone.

The amount of additional compounds present in any of the foregoing refrigerant compositions can be greater than 0 ppm and less than 5,000 ppm and, in particular, can range from about 5 to about 1,000 ppm, about 5 to about 500 ppm and about 5 to about 100 ppm.

In one embodiment, the amount of additional compounds present in any of the foregoing refrigerant compositions can be greater than 0 and less than 1 wt % of the refrigerant composition

In one embodiment, the amount of the fluoroethane (HFC-161) present in any of the foregoing refrigerant compositions is between 1 weight percent and 15 weight percent based on the total refrigerant composition. In one particular embodiment, the amount of fluoroethane (HFC-161) is between 1 weight percent and 10 weight percent based on the total refrigerant composition and, in one specific aspect, the compositions further comprise at least one additional compound: (a) at least one member selected from the group consisting of 244bb, 245cb, 254eb, 1234ze, 12, 124, TFPY, 1140, 1225ye, 1225zc, 134a, 1243zf, 1131, ethylene, diethyl ether, ethyl ether, ethane, butane, isobutane, CO2, HFP, TFPY, ethyl chloride, and acetone; (b) at least one member selected from the group consisting of 134, 23, 125, 143a, 134a, 1234ze, 1243zf, 245fa, 1131, 1122, 244bb, 245cb, 245eb, 1233xf, 1224, 1132a, 1131a, 12, HFP, ethylene, diethyl ether, ethyl ether, ethane, butane, isobutane, CO2, HFP, TFPY, ethyl chloride, and acetone; or (c) at least one additional member selected from the group consisting of methane, ethane, 143a, 1234ze, ethylene oxide, 1123, 1243zf, propane, 23, 263fb, 124, 254eb, 1224yd, ethylene, diethyl ether, ethyl ether, ethane, butane, isobutane, CO2, HFP, TFPY, ethyl chloride and acetone; and wherein the additional compound is present in an amount greater than 0 and less than 1 wt. % of the refrigerant composition.

In one embodiment, any of the foregoing refrigerant compositions can further comprise an additional compound comprising at least one of an oligomer and a homopolymer of 1234yf. The amount can range from greater than 0 to about 100 ppm, and in some case, about 2 ppm to about 100 ppm. In an aspect of this embodiment, the refrigerant comprises 1234yf and about 1 to about 10 wt. % 161 and, in a further aspect, the refrigerant composition further comprises greater than about 0 and less than 1 wt. % of additional compounds in addition to the oligomer and homopolymer.

Another embodiment of the invention relates to storing the foregoing compositions in gaseous and/or liquid phases within a sealed container wherein the oxygen and/or water concentration in the gas and/or liquid phases ranges from about 3 vol ppm to less than about 3,00 vol ppm at a temperature of about 25C, about 5 vol ppm to less than about 150 vol ppm and in some cases about 5 vol ppm to less than about 75 vol ppm. In an aspect of this embodiment, the refrigerant comprises 1234yf and about 1 to about 10 wt. % 161 and, in a further aspect, the refrigerant composition further comprises greater than about 0 and less than 1 wt. % of additional compounds.

The container for storing the foregoing compositions can be constructed of any suitable material and design that is capable of sealing the compositions therein while maintaining gaseous and liquids phases. Examples of suitable containers comprise pressure resistant containers such as a tank, a filling cylinder, and a secondary filing cylinder. The container can be constructed from any suitable material such as carbon steel, manganese steel, chromium-molybdenum steel, among other low-alloy steels, stainless steel and in some case an aluminum alloy.

The compositions of the present invention may be prepared by any convenient method to combine the desired amount of the individual components. A preferred method is to weigh the desired component amounts and thereafter combine the components in an appropriate vessel. Agitation may be used, if desired. In another embodiment, any of the foregoing refrigerant composition can be prepared by blending HFO-1234yf, R-161 and, in some cases, at least one of the additional compositions.

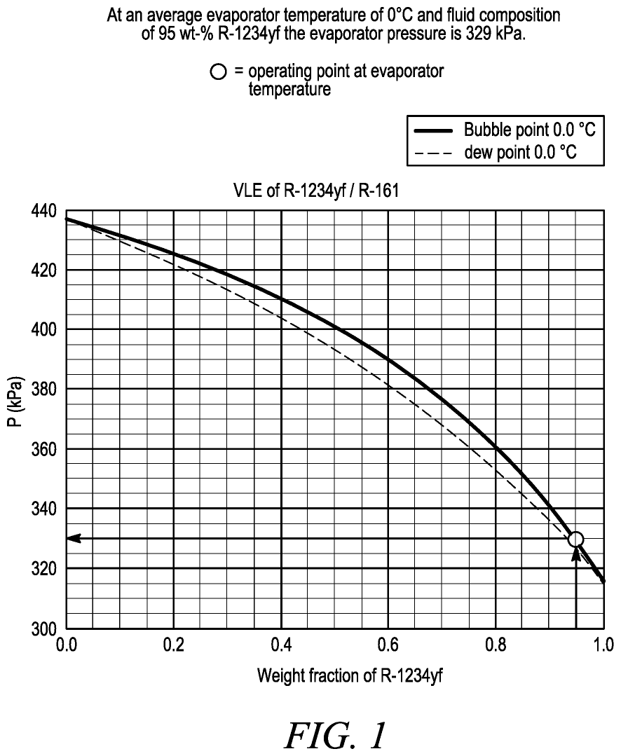

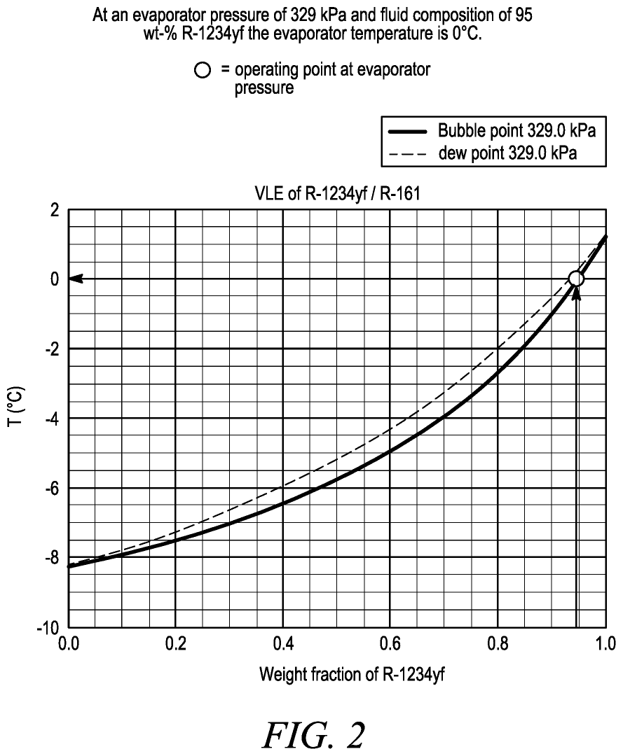

The properties of the refrigerant blends are further described in FIGS. 1-5. FIG. 1 illustrates the evaporator pressure over the full range of weight fractions for the binary system of 2,3,3,3-tetrafluoropropene (HF0-1234y0 and fluoroethane (HFC-161). The data is presented at an evaporator temperature of 0 degrees Celsius. FIG. 2 illustrates the temperature at which the refrigerant blends result in a 327.0 kPa evaporator pressure over the full range of weight fractions for the binary system of 2,3,3,3-tetrafluoropropene (HFO-1234yf) and fluoroethane (HFC-161).

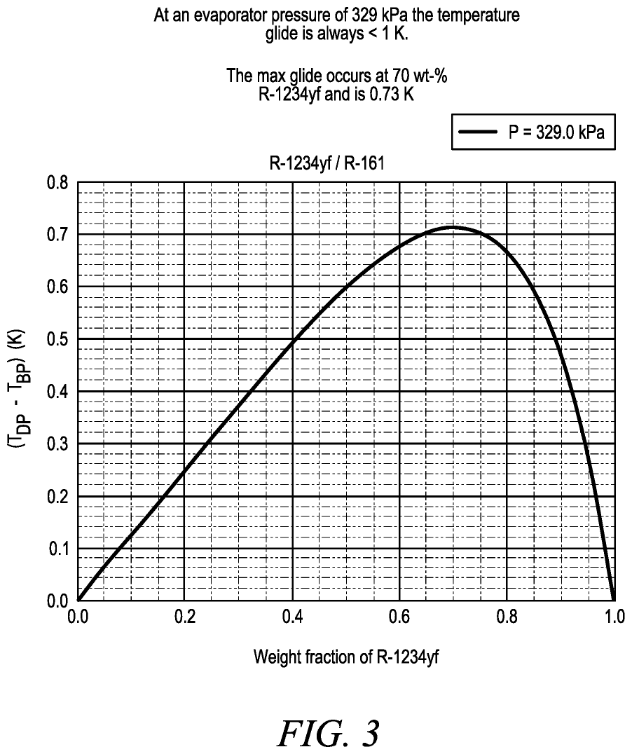

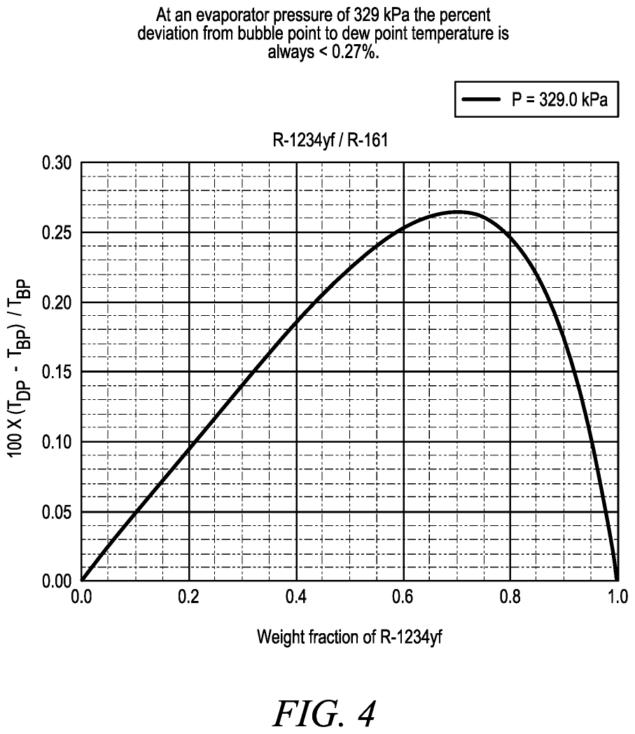

FIGS. 3 and 4 illustrate the temperature glide of the refrigerant blends as a function of weight fraction of HFO-1234yf in absolute terms and as a percentage. The data is presented at an evaporator pressure of 327.0 kPa. The data illustrates that the temperature glide of a binary 2,3,3,3-tetrafluoropropene (HFO-1234yf) / fluoroethane (HFC-161) refrigerant blend is near-azeotropic, with a maximum glide of 0.73 Kelvin occurring at about 70 weight percent HFO-1234yf. The temperature glide corresponding to the 0.95 weight fraction of HFO-1234yf is about 0.27 degrees Kelvin. In certain embodiments, the refrigerant composition according to the present invention, includes a temperature glide of less than or equal to 0.5 Kelvin (K) or less than 0.1 at temperatures of −30° C. up to 10° C. In other embodiments, the refrigerant composition according to the present invention, includes a temperature glide of less than or equal to 0.1 Kelvin (K) or less than 0.05 at temperatures of 20° C. up to 40° C.

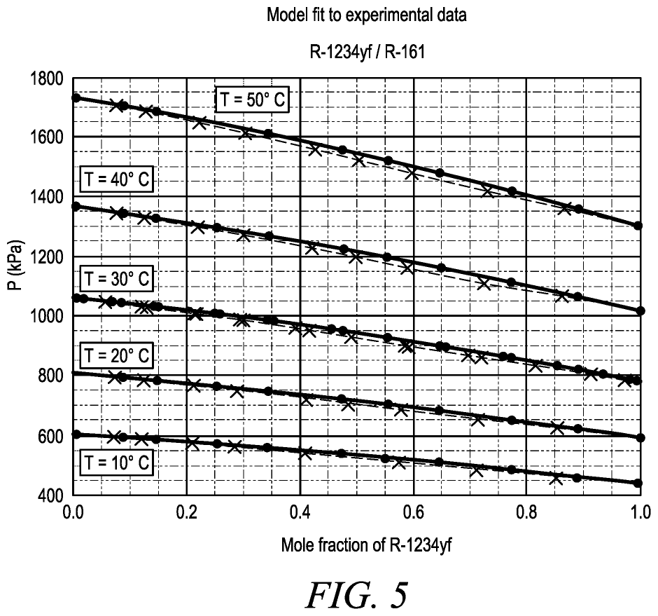

FIG. 5 illustrates that blends of 2,3,3,3-tetrafluoropropene (HFO-1234yf) and fluoroethane (HFC-161) exhibit near-azeotropic properties over a wide range of mole fractions and evaporator temperatures.

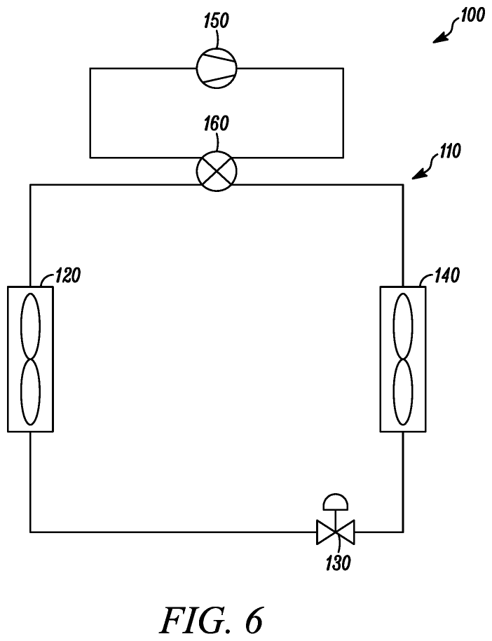

The refrigerant blends may be used in a variety of heating and cooling systems. In the embodiment of FIG. 6, a refrigeration system 100 having a refrigeration loop 110 comprises a first heat exchanger 120, a pressure regulator 130 a second heat exchanger 140, a compressor 150 and a four-way valve 160. The first and second heat exchangers are of the air/refrigerant type. The first heat exchanger 120 has passing through it the refrigerant of the loop 110 and the stream of air created by a fan. All or some of this same air stream may also pass through a heat exchanger an external cooling circuit, such as an engine (not depicted in the figure). Likewise, the second heat exchanger 140 has passing through it an air stream created by a fan. All or some of this air stream may also pass through another external cooling circuit (not depicted in the figure). The direction in which the air flows is dependent on the mode of operation of the loop 110 and on the requirements of the external cooling circuit. Thus, in the case of an engine, when the engine is idle and the loop 110 is in heat pump mode, the air can be heated up by the heat exchanger of the engine cooling circuit and then blown onto the heat exchanger 120 to speed up the evaporation of the fluid of the loop 110 and thus improve the performance of this loop. The heat exchangers of the cooling circuit may be activated by valves according to engine requirements, such as, heating of the air entering the engine or putting the energy produced by this engine to productive use.

In refrigeration mode, the refrigerant set in motion by the compressor 150 passes, via the valve 160, through the heat exchanger 120 which acts as a condenser, that is to say gives up heat energy to the outside, then through the pressure regulator 130 then through the heat exchanger 140 that is acting as an evaporator thus cooling the stream of air intended to be blown into the motor vehicle cabin interior.

In heat pump mode, the direction of flow of the refrigerant is reversed using the valve 160. The heat exchanger 140 acts as a condenser while the heat exchanger 120 acts as an evaporator. The heat exchanger 140 can then be used to heat up the stream of air intended for the motor vehicle cabin.

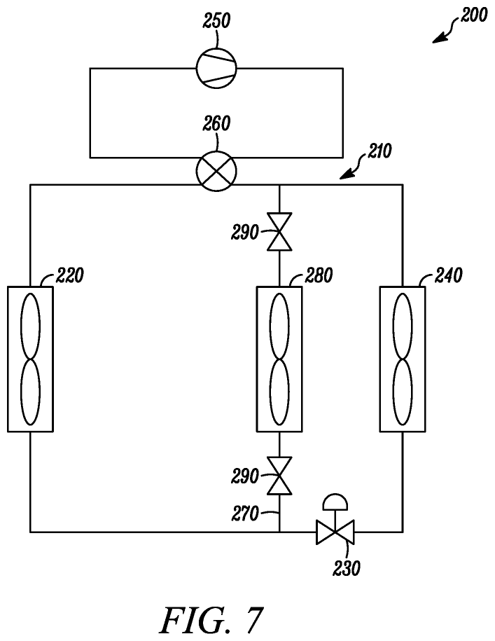

In the embodiment of FIG. 7, a refrigeration system 200 having a refrigeration loop 210 comprises a first heat exchanger 220, a pressure regulator 230, a second heat exchanger 240, a compressor 250, a four-way valve 260, and a branch-off 270 mounted, on the one hand, at the exit of the heat exchanger 220 and, on the other hand, at the exit of the heat exchanger 240 when considering the direction of flow of the fluid in refrigeration mode. This branch comprises a heat exchanger 280 through which there passes a stream of air or stream of exhaust gas which is intended to be admitted to the engine and a pressure regulator 280. The first and second heat exchangers 220 and 240 are of the air/refrigerant type. The first heat exchanger 220 has passing through it the refrigerant from the loop 210 and the stream of air introduced by a fan. All or some of this same air stream also passes through a heat exchanger of the engine cooling circuit (not depicted in the figure). Likewise, the second exchanger 240 has, passing through it, a stream of air conveyed by a fan. All or some of this air stream also passes through another heat exchanger of the engine cooling circuit (not depicted in the figure). The direction in which the air flows is dependent on the mode of operation of the loop 210 and on the engine requirements. By way of example, when the combustion engine is idle and the loop 210 is in heat pump mode, the air may be heated by the heat exchanger of the engine cooling circuit and then blown onto the heat exchanger 220 to accelerate the evaporation of fluid of the loop 210 and improve the performance of this loop. The heat exchangers of the cooling circuit may be activated by valves according to engine requirements, such as, heating of the air entering the engine or putting the energy produced by this engine to productive use.

The heat exchanger 280 may also be activated according to energy requirements, whether this is in refrigeration mode or in heat pump mode. Shut-off valves 290 can be installed on the branch 270 to activate or deactivate this branch.

A stream of air conveyed by a fan passes through the heat exchanger 280. This same air stream may pass through another heat exchanger of the engine cooling circuit and also through other heat exchangers placed in the exhaust gas circuit, on the engine air inlet or on the battery in the case of hybrid motorcars.

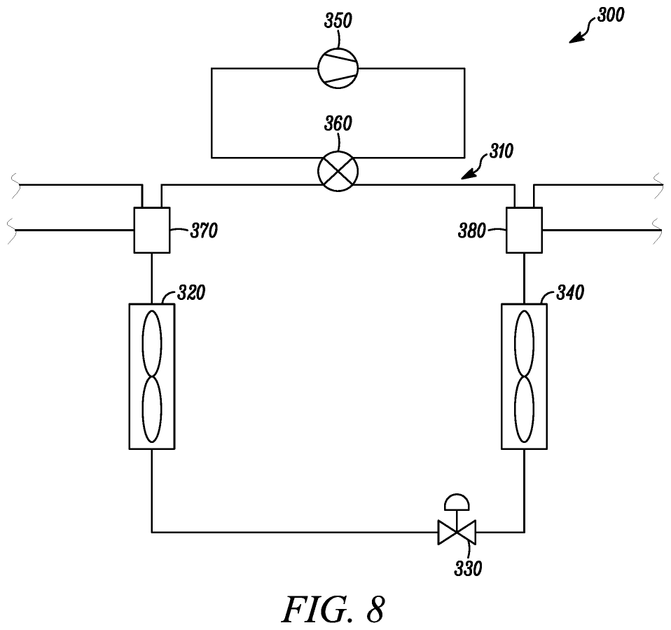

In the embodiment of FIG. 8, a refrigeration system 300 having a refrigeration loop 310 comprises a first heat exchanger 320, a pressure regulator 330, a second heat exchanger 340, a compressor 350 and a four-way valve 360. The first and second heat exchangers 320 and 340 are of the air/refrigerant type. The way in which the heat exchangers 320 and 340 operate is the same as in the first embodiment depicted in FIG. 6. Two fluid/liquid heat exchangers 370 and 380 are installed both on the refrigeration loop circuit 310 and on the engine cooling circuit or on a secondary glycol-water circuit. Installing fluid/liquid heat exchangers without going through an intermediate gaseous fluid (air) contributes to improving heat exchange by comparison with air/fluid heat exchangers.

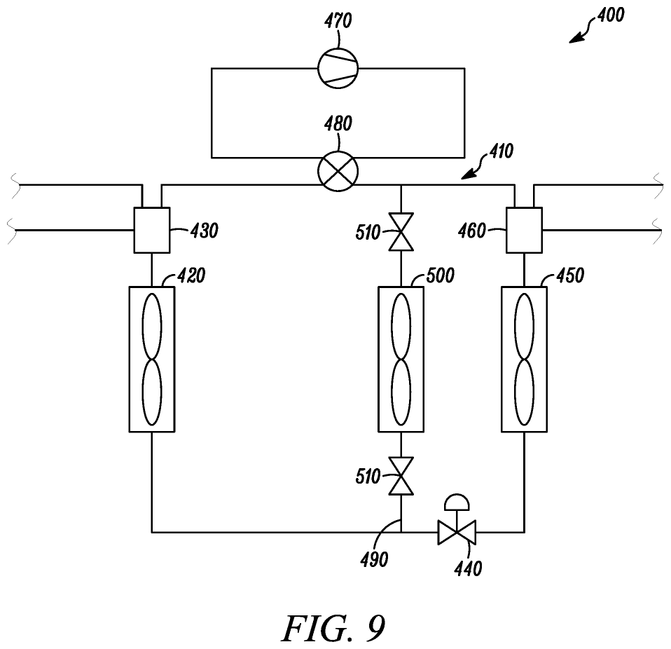

In the embodiment of FIG. 9, a refrigeration system 400 having a refrigeration loop 410 comprises a first series of heat exchangers 420 and 430, a pressure regulator 440, a second series of heat exchangers 450 and 460, a compressor 470 and a four-way valve 480. A branch-off 490 mounted, on the one hand, at the exit of the heat exchanger 420 and, on the other hand, at the exit of the heat exchanger 460, when considering the circulation of the fluid in refrigerant mode. This branch comprises a heat exchanger 500 through which there passes a stream of air or a stream of exhaust gases intended to be admitted to a combustion engine and a pressure regulator 510. The way in which this branch operates is the same as in the second embodiment depicted in FIG. 7.

The heat exchangers 420 and 450 are of the air/refrigerant type and the heat exchangers 430 and 460 are of the liquid/refrigerant type. The way in which these heat exchangers work is the same as in the third embodiment depicted in FIG. 8.

The blends have ultra-low GWP, low toxicity, and low flammability with low temperature glide or nearly negligible glide for use in a hybrid, mild hybrid, plug-in hybrid, or full electric vehicles for thermal management (transferring heat from one part of the vehicle to the other) of the passenger compartment providing air conditioning (A/C) or heating to the passenger cabin.

In other embodiments, including compositions intended to replace conventional high GWP refrigerant and for heat pump applications, it is desirable that the refrigerant composition exhibit a low GWP as well as similar or improved refrigerant properties compared to conventional refrigerants.

The following Examples are provided to illustrate certain aspects of the invention and shall not limit the scope of the appended claims.

### EXAMPLES

### Example 1

Thermodynamic Modeling Comparison for the Heat Pump Systems HEATING MODE: R-1234yf/R-161

A thermodynamic modeling program, Thermocycle 3.0, was used to model the expected performance of the blend versus HFO-1234yf/R-161 compared to HFO1-234yf. Model conditions used for the heating mode are as follows, where heat exchanger #2 was varied in 10° C. increments:

### Modeling Conditions

| Heat Exchanger #1-Inside Cabin | 50° C. |
|---|---|
| Heat Exchange #2-Outside Air | −30° C. to 10° C. |
| (Ambient Air Temp) | |
| Return Gas Heated | 10° C. |
| Compressor Efficiency | 70% |

TABLE 2
Heat Exchanger #2 = −30° C.

| | | | | | | | Relative | | | |
|---|---|---|---|---|---|---|---|---|---|---|
| | Com- | Com- | Com- | Com- | | | (%) | | Relative | |
| | pressor | pressor | pressor | pressor | Com- | | Heating | | (%) | |
| | Inlet | Disc | Inlet | Disc | pressor | Heating | Capacity | | Heating | Ave |
| | Temp | Temp | Pres | Pres | Discharge | Capacity | vs | COP | COP vs | Glide |
| Refrigerant | (° C.) | (° C.) | (kPa) | (kPa) | Ratio | (kJ/m3) | R-1234yf | Heating | R-1234yf | (K) |
| R-1234yf | −20 | 74.8 | 98.3 | 1299.7 | 13.2 | 831.6 | 100.0 | 2.18 | 100.0 | |
| R-1234yf/R-161 | −20 | 75.6 | 98.9 | 1307.1 | 13.2 | 841.1 | 101.1 | 2.187 | 100.3 | 0.01 |
| (99 wt %/1 wt %) | | | | | | | | | | |
| R-1234yf/R-161 | −20 | 78.7 | 101.5 | 1335.5 | 13.2 | 878.0 | 105.6 | 2.22 | 101.6 | 0.05 |
| (95 wt %/5 wt %) | | | | | | | | | | |
| R-1234yf/R-161 | −20 | 82.5 | 104.5 | 1368.8 | 13.1 | 921.7 | 110.8 | 2.244 | 102.9 | 0.08 |
| (90 wt %/10 wt %) | | | | | | | | | | |

TABLE 3
Heat Exchanger #2 = −20° C.

| | | | | | | | Relative | | | |
|---|---|---|---|---|---|---|---|---|---|---|
| | Com- | Com- | Com- | Com- | | | (%) | | Relative | |
| | pressor | pressor | pressor | pressor | Com- | | Heating | | (%) | |
| | Inlet | Disc | Inlet | Disc | pressor | Heating | Capacity | | Heating | Ave |
| | Temp | Temp | Pres | Pres | Discharge | Capacity | vs | COP | COP vs | Glide |
| Refrigerant | (° C.) | (° C.) | (kPa) | (kPa) | Ratio | (kJ/m3) | R-1234yf | Heating | R-1234yf | (K) |
| R-1234yf | −10 | 71.2 | 149.9 | 1299.7 | 8.7 | 1204.9 | 100.0 | 2.53 | 100.0 | |
| R-1234yf/R-161 | −10 | 71.9 | 150.9 | 1307.1 | 8.7 | 1217.6 | 101.1 | 2.54 | 100.2 | 0.01 |
| (99 wt %/1 wt %) | | | | | | | | | | |
| R-1234yf/R-161 | −10 | 74.5 | 154.6 | 1335.5 | 8.6 | 1266.8 | 105.1 | 2.56 | 101.3 | 0.05 |
| (95 wt %/ 5 wt %) | | | | | | | | | | |
| R-1234yf/R-161 | −10 | 77.7 | 159.0 | 1368.8 | 8.6 | 1324.9 | 110.0 | 2.59 | 102.5 | 0.08 |
| (90 wt %/10 wt %) | | | | | | | | | | |

TABLE 4
Heat Exchanger #2 = −10° C.

| | | | | | | | Relative | | | |
|---|---|---|---|---|---|---|---|---|---|---|
| | Com- | Com- | Com- | Com- | | | (%) | | Relative | |
| | pressor | pressor | pressor | pressor | Com- | | Heating | | (%) | |
| | Inlet | Disc | Inlet | Disc | pressor | Heating | Capacity | | Heating | Ave |
| | Temp | Temp | Pres | Pres | Discharge | Capacity | vs | COP | COP vs | Glide |
| Refrigerant | (° C.) | (° C.) | (kPa) | (kPa) | Ratio | (kj/m3) | R-1234yf | Heating | R-1234yf | (K) |
| R-1234yf | 0 | 68.4 | 220.5 | 1299.7 | 5.9 | 1699.1 | 100.0 | 3.00 | 100.0 | |
| R-1234yf/R-161 | 0 | 69.0 | 221.9 | 1307.1 | 5.9 | 1715.6 | 101.0 | 3.011 | 100.4 | 0.01 |
| (99 wt %/1 wt %) | | | | | | | | | | |
| R-1234yf/R-161 | 0 | 71.2 | 227.1 | 1335.5 | 5.9 | 1779.4 | 104.7 | 3.04 | 101.3 | 0.05 |
| (95 wt %/5 wt %) | | | | | | | | | | |
| R-1234yf/R-161 | 0 | 73.8 | 233.3 | 1368.8 | 5.9 | 1854.6 | 109.1 | 3.068 | 102.3 | 0.08 |
| (90 wt %/10 wt %) | | | | | | | | | | |

TABLE 5
Heat Exchanger #2 = 0° C.

| | | | | | | | Relative | | | |
|---|---|---|---|---|---|---|---|---|---|---|
| | Com- | Com- | Com- | | | | (%) | | Relative | |
| | pressor | pressor | pressor | Com- | Com- | | Heating | | (%) | |
| | Inlet | Disc | Inlet | pressor | pressor | Heating | Capacity | | Heating | Ave |
| | Temp | Temp | Pres | Disc Pres | Discharge | Capacity | vs | COP | COP vs | Glide |
| Refrigerant | (° C.) | (° C.) | (kPa) | (kPa) | Ratio | (kj/m3) | R-1234yf | Heating | R-1234yf | (K) |
| R-1234yf | 10 | 66.2 | 314.2 | 1299.7 | 4.1 | 2342.3 | 100.0 | 3.68 | 100.0 | |
| R-1234yf/R-161 | 10 | 66.7 | 316.1 | 1307.1 | 4.1 | 2363.2 | 100.9 | 3.69 | 100.3 | 0.01 |
| (99 wt %/ 1 wt %) | | | | | | | | | | |
| R-1234yf/R-161 | 10 | 68.5 | 323.3 | 1335.5 | 4.1 | 2443.8 | 104.3 | 3.71 | 100.9 | 0.03 |
| (95 wt %/5 wt %) | | | | | | | | | | |
| R-1234yf/R-161 | 10 | 70.6 | 331.9 | 1368.8 | 4.1 | 2538.6 | 108.4 | 3.74 | 101.7 | 0.08 |
| (90 wt %/ 10 wt %) | | | | | | | | | | |

TABLE 6
Heat Exchanger #2 = 10° C.

| | | | | | | | Relative | | | |
|---|---|---|---|---|---|---|---|---|---|---|
| | Com- | Com- | Com- | Com- | | | (%) | | Relative | |
| | pressor | pressor | pressor | pressor | Com- | | Heating | | (%) | |
| | Inlet | Disc | Inlet | Disc | pressor | Heating | Capacity | | Heating | Ave |
| | Temp | Temp | Pres | Pres | Discharge | Capacity | vs | COP | COP vs | Glide |
| Refrigerant | (° C.) | (° C.) | (kPa) | (kPa) | Ratio | (kJ/m3) | R-1234yf | Heating | R-1234yf | (K) |
| R-1234yf | 20 | 64.5 | 435.5 | 1299.7 | 3.0 | 3168.1 | 100.0 | 4.70 | 100.0 | |
| R-1234yf/R-161 | 20 | 64.9 | 438.0 | 1307.1 | 3.0 | 3193.9 | 100.8 | 4.71 | 100.2 | 0.01 |
| (99 wt %/1 wt %) | | | | | | | | | | |
| R-1234yf/R-161 | 20 | 66.3 | 447.9 | 1335.5 | 3.0 | 3293.5 | 104.0 | 4.73 | 100.7 | 0.03 |
| (95 wt %/5 wt %) | | | | | | | | | | |
| R-1234yf/R-161 | 20 | 67.9 | 459.5 | 1368.8 | 3.0 | 3410.4 | 107.6 | 4.76 | 101.3 | 0.05 |
| (90 wt %/10 wt %) | | | | | | | | | | |

Modeling results show that blends of HFO-1234yf with R-161 from 1 wt % to 10 wt % provide a significant advantage over neat HFO-1234yf. At −30° C. ambient temperatures, HFO-1234yf does not perform well. The compressor inlet pressure is sub-atmospheric and air would be pulled into the compressor. Therefore, HFO-1234yf is limited for use as a heat pump fluid to −20° C. without some sort system design. However, even 5 wt % R-161 (fluoroethane) improves the performance of the resultant blend with HFO-1234yf (99 wt %)/ R-161 (1 wt %) being able to operate at temperatures down to −30° C. Therefore, the inventive blends of HFO-1234yf/R-161 extend the heating range by a delta of 10° C.

Blends of HFO-1234yf with R-161 (fluoroethane) from 1 wt % to 10 wt % also provide an advantage over neat HFO-1234yf in terms of improved heating capacity. Modeling results show that 5 wt % of R-161 has about 5% heat capacity improvement while up to 10% R-161 can significantly improve the relative heat capacity up to 10%. The improved heating capacity of the inventive blends shows that the new fluids can easily be used to provide adequate heat to a passenger cabin. Additionally, the resultant inventive blends generally have a similar compressor discharge ratio versus neat HFO-1234yf over the heat pump operating range.

Modeling shows that blends of HFO-1234yf and R-161 (fluoroethane) from 1 wt % to 10 wt % have equivalent or increased COP or energy performance in the heating range of −30° C. to +10° C. Additionally, blends which contain 1 to 10 wt % R-161 (fluoroethane) also exhibit near negligible glide over the desired heating range, i.e., from −30° C. up to 10° C. Therefore, the R-161 blends have extremely favorable glide and can be serviced as near azeotropic blends over the entire heating range without limitation.

Therefore, the HFO-1234yf/R-161 refrigerant blends noted herein uniquely provide improved capacity over HFO-1234yf in the heating operating range from −30° C. to +10° C., extend the lower heating range capability over HFO-1234yf by a delta of 10C, have extremely low GWP (less than 10) and low to mild flammability (class 2 to class 2L), while also uniquely exhibiting nearly negligible glide over heating range for servicing.

While all blends of HFO-1234yf and R-161 would be desirable, the preferred blends with advantageous flammability for a heat pump fluid are 99 wt % HFO-1234yf to 76.2 wt % HFO-1234yf and 1 wt % R-161 to 23.8 wt % R-161, with more preferred blends being 99 wt % HFO-1234yf to 90 wt % HFO-1234yf and 1 wt % to 10 wt % R-161 and most preferred blend being 99% HFO-1234yf to 93 wt % HFO-1234yf and 1 wt % R-161 to 7 wt % R-161.

### EXAMPLE 2

### Cooling Mode: HFO-1234yf/R-161

### Thermodynamic Modeling Comparison for the Heat Pump Systems

A thermodynamic modeling program, Thermocycle 3.0, was used to model the expected performance of the blend versus HFO-1234yf compared to HFO-1234yf/R-161.

Model conditions used for the cooling mode are as follows, where heat exchanger #2 was varied in 10C increments:

### Modeling Conditions

| Heat Exchanger #1-Inside Cabin | 0° C. |
|---|---|
| Heat Exchange #2-Outside Air | 20° C. to 40° C. |
| (Ambient Air Temp) | |
| Superheat | 10° C. |
| Compressor Efficiency | 70% |

TABLE 7
Heat Exchanger #2 = 40° C.

| | | | | | | | Relative | | | |
|---|---|---|---|---|---|---|---|---|---|---|
| | Com- | Com- | Com- | Com- | | | (%) | | Relative | |
| | pressor | pressor | pressor | pressor | Com- | | Cooling | | (%) | |
| | Inlet | Disc | Inlet | Disc | pressor | Cooling | Capacity | | Cooling | Ave |
| | Temp | Temp | Pres | Pres | Discharge | Capacity | vs | COP | COP vs | Glide |
| Refrigerant | (° C.) | (° C.) | (kPa) | (kPa) | Ratio | (kJ/m3) | R-1234yf | Cooling | R-1234yf | (K) |
| R-1234yf | 10 | 55.6 | 314.2 | 1015.6 | 3.2 | 1961.5 | 100.0 | 3.71 | 100.0 | |
| R-1234yf/R-161 | 10 | 56.0 | 316.1 | 1021.5 | 3.2 | 1977.9 | 100.8 | 3.72 | 100.3 | 0.00 |
| (99 wt %/1 wt %) | | | | | | | | | | |
| R-1234yf/R-161 | 10 | 57.5 | 323.4 | 1044.0 | 3.2 | 2041.1 | 104.1 | 3.74 | 100.8 | 0.03 |
| (95 wt %/5 wt %) | | | | | | | | | | |
| R-1234yf/R-161 | 10 | 59.3 | 332.1 | 1070.4 | 3.2 | 2115.3 | 107.8 | 3.764 | 101.5 | 0.05 |
| (90 wt %/10 wt %) | | | | | | | | | | |

TABLE 8
Heat Exchanger #2 = 30° C.

| | | | | | | | Relative | | | |
|---|---|---|---|---|---|---|---|---|---|---|
| | Com- | Com- | Com- | Com- | | | (%) | | Relative | |
| | pressor | pressor | pressor | pressor | Com- | | Cooling | | (%) | |
| | Inlet | Disc | Inlet | Disc | pressor | Cooling | Capacity | | Cooling | Ave |
| | Temp | Temp | Pres | Pres | Discharge | Capacity | vs | COP | COP vs | Glide |
| Refrigerant | (° C.) | (° C.) | (kPa) | (kPa) | Ratio | (kJ/m3) | R-1234yf | Cooling | R-1234yf | (K) |
| R-1234yf | 10 | 44.8 | 314.2 | 780.8 | 2.5 | 2204.5 | 100.0 | 5.36 | 100.0 | |
| R-1234yf/R-161 | 10 | 45.1 | 316.1 | 785.4 | 2.5 | 2220.7 | 100.7 | 5.37 | 100.1 | 0.00 |
| (99 wt %/1 wt %) | | | | | | | | | | |
| R-1234yf/R-161 | 10 | 46.3 | 323.5 | 803.0 | 2.5 | 2283.5 | 103.6 | 5.384 | 100.4 | 0.03 |
| (95 wt %/5 wt %) | | | | | | | | | | |
| R-1234yf/R-161 | 10 | 47.7 | 332.2 | 823.6 | 2.5 | 2357.1 | 106.9 | 5.40 | 100.8 | 0.03 |
| (90 wt %/ 10 wt %) | | | | | | | | | | |

TABLE 9
Heat Exchanger #2 = 20° C.

| | | | | | | | Relative | | | |
|---|---|---|---|---|---|---|---|---|---|---|
| | Com- | Com- | Com- | Com- | | | (%) | | Relative | |
| | pressor | pressor | pressor | pressor | Com- | | Cooling | | (%) | |
| | Inlet | Disc | Inlet | Disc | pressor | Cooling | Capacity | | Cooling | Ave |
| | Temp | Temp | Pres | Pres | Discharge | Capacity | vs | COP | COP vs | Glide |
| Refrigerant | (° C.) | (° C.) | (kPa) | (kPa) | Ratio | (kJ/m3) | R-1234yf | Cooling | R-1234yf | (K) |
| R-1234yf | 10 | 33.7 | 314.2 | 589.3 | 1.9 | 2437.2 | 100.0 | 8.58 | 100.0 | |
| R-1234yf/R-161 | 10 | 34.0 | 316.1 | 592.8 | 1.9 | 2453.4 | 100.7 | 8.581 | 100.0 | 0.00 |
| (99 wt %/1 wt %) | | | | | | | | | | |
| R-1234yf/R-161 | 10 | 34.7 | 323.6 | 606.4 | 1.9 | 2515.5 | 103.2 | 8.59 | 100.1 | 0.01 |
| (95 wt %/5 wt %) | | | | | | | | | | |
| R-1234yf/R-161 | 10 | 35.7 | 332.4 | 622.2 | 1.9 | 2588.3 | 106.2 | 8.60 | 100.2 | 0.03 |
| (90 wt %/10 wt %) | | | | | | | | | | |

For any heat pump fluid to be a viable candidate, it needs to also perform well in the cooling mode, i.e., in higher ambient temperatures it needs to provide adequate cooling. Modeling results show that blends of HFO-1234yf with R-161 from 1 wt % to 10 wt % provide an equivalent or improved cooling advantage over neat HFO-1234yf in the cooling range from 20° C. up to 40° C. ambient.

Blends of HFO-1234yf with R-161 (fluoroethane) from 1 wt % to 10 wt % also provide an advantage over neat HFO-1234yf in terms of improved cooling capacity. The equivalent or improved cooling capacity of the inventive blends shows that the new fluids can easily be used to provide adequate cooling (air-conditioning) to a passenger cabin. Additionally, the resultant inventive blends generally have a similar compressor discharge ratio versus neat HFO-2134yf over the cooling operating range.

Modeling shows that blends of HFO-1234yf and R-161 (fluoroethane) from 1 wt % to 10 wt % have similar COP or energy performance in the cooling range from +20 to +40° C.

Additionally, blends which contain 1 to 10 wt % R-161 (fluoroethane) also exhibit negligible glide over the desired cooling range, i.e., from +20° C. to +40° C. Therefore, this inventive blend can be serviced in almost any ambient environment.

Therefore, the HFO-1234yf/R-161 refrigerant blends noted herein uniquely provide improved capacity 2% to 22% over HFO-1234yf in the cooling operating range from +20° C. to +40° C., have extremely low GWP (less than 10) and low to mild flammability (class 2 to class 2L), while also uniquely exhibiting nearly negligible glide for all heat pump operating temperatures.

### EXAMPLE 3

The flammability of 1234yf/161 blends was measured in accordance with ASTM E681. The results of the measurement are listed below in Table 10.

TABLE 10
“LFL” is lower in flammability limit and
“UFL” is upper flammability limit.

| | | E681 | | |
|---|---|---|---|---|
| R-1234yf | R-161 | Test | LFL in | UFL in |
| in wt % | in wt % | Temp | vol % | vol % |
| 100 | | | 6.2 | 12.3 |
| | 100 | 23 | 3.50 | 15.50 |
| | 100 | 60 | 3.30 | 15.80 |
| 95 | 5 | 23 | 5.10 | 14.00 |
| 95 | 5 | 23 | 5.00 | 13.77 |
| 95 | 5 | 60 | 4.75 | 15.00 |
| 95 | 5 | 60 | 4.80 | 14.60 |
| 90 | 10 | 23 | 4.75 | 15.00 |
| 90 | 10 | 23 | 4.55 | 15.00 |
| 90 | 10 | 60 | 4.50 | 15.25 |
| 90 | 10 | 60 | 4.50 | 15.15 |

HFO-1234yf is rated as a A2L refrigerant. R-161 is a proposed class A refrigerant for toxicity with class 2 or 3 flammability. Table 10 illustrates one benefit of the invention in that by blending 1234yf with R-161, refrigeration performance properties are improved while maintaining an A2L flammability rating. A2L flammability is defined as having HOC <19KJ/kg and <10 cm/sec per ISO 817 and ANSI/ASHRAE 34. Table 10 illustrates that a blend comprising greater than 0 to at least 10% R-161 has a BV of less than 10 cm/sec and a desirable LFL compared to neat R-161 (4.5-5.0 vol % compared to 3.4 vol %.)

The flammability of 1234yf/161 blends in combination with a perfluoropolyether lubricant (Krytox® oil) was measured in accordance with ASTM E681. The results of the measurement are listed below in Table 11. These results illustrate that the presence of the tested lubricant oil does not significantly change the LFL of 1234yf/161 blends which is an unexpected and desirable improvement over other non-fluorinated lubricants. Generally, lubricants reduce the LFL of refrigerants (increasing the flammability of said blend.) However, in this case, the resultant blend did not decrease in flammability level. This implies that adding perfluoropolyether lubricants to a thermal management system (e.g., an automotive heat pump system), can take full advantage of the refrigerant/lubricant performance without negatively impacting flammability.

TABLE 11

| R-1234yf | R-161 | Krytox ® Oil | | E681 Test | LFL in | UFL in |
|---|---|---|---|---|---|---|
| in wt % | in wt % | Type | wt % | Temp | vol % | vol % |
| 94 | 3 | GPL104 | 3 | 23 | 5.25 | 14.25 |
| 94 | 3 | GPL104 | 3 | 60 | 5.25 | 14.25 |
| 92.2 | 5 | GLP105 | 2.8 | 60 | 4.65 | 15.14 |
| 92.2 | 5 | GLP105 | 2.8 | 60 | 5.00 | 14.40 |
| 95 | 5 | | | 60 | 4.75 | 15.00 |
| 95 | 5 | | | 60 | 4.80 | 14.60 |

The burning velocity (BV or speed at which a flame propagates) of 1234yf/161 blends was measured and the results listed in Table 12.

TABLE 12

| R-1234yf | R-161 | BV | | Flammability |
|---|---|---|---|---|
| in wt % | in wt % | in cm/sec | Test Method | Rating |
| 100 | — | 1.5 | Schlerien method | 2 L |
| | | | by AIST | |
| 99 | 1 | no propagation, | Vertical Tube | 2 L |
| | | ie <4 | method by ISO | |
| | | | 817 | |
| 98.3 | 1.7 | no propagation, | Vertical Tube | 2 L |
| | | ie <4 | method by ISO | |
| | | | 817 | |
| 97.6 | 2.4 | 4-5.5 | Vertical Tube | 2 L |
| | | | method by ISO | |
| | | | 817 | |
| 97 | 3 | <6 | Vertical Tube | 2 L |
| | | | method by ISO | |
| | | | 817 | |
| 96 | 4 | ~6.7 | Vertical Tube | 2 L |
| | | | method by ISO | |
| | | | 817 | |
| 95.2 | 4.8 | >6.7 | Vertical Tube | 2 L |
| | | | method by ISO | |
| | | | 817 | |
| 93.0 | 7.0 | 8.2 | Vertical Tube | 2 L |
| | | | method by ISO | |
| | | | 817 | |
| 90 | 10 | <10 | Calculated* | 2 L |

The Japanese National Institute of Advanced Industrial Science and Technology (AIST) had previously measured BV for HFO-1234yf using high-speed Schlieren photography and was found to be 1.5 cm/sec. BV for the R-161/YF blends was measured using the vertical tube described in ISO 817:2014. ISO 817:2104 Annex C provides details regarding the BV method developed by Jabbour and Clodic (detailed description for this method can be found in both Jabbour, T., Flammable refrigerant classification based on the burning velocity. PhD Thesis, Ecole des Mines: Paris, France, 2004 and in Jabbour. T. and Clodic, D.F., Burning velocity and refrigerant flammability classification. ASHRAE Transactions 110(2), 2004.) In accordance with this BV method, the refrigerant blend is ignited at the base of a 1.3 m long vertical tube with internal diameter of 40 mm and outer diameter of 50 mm, manufactured bBODY y Schott glass. Flame propagation up the vertical tube was recorded using a Sony FDR-AX100 camera with 120 frames per second capability. Image processing software from Image Pro Insight version 8.0 was used to analyze the recorded flame front . The maximum burning velocity is calculated per the following equation:

$${S}_{u} = {S}_{s} \frac{{a}_{f}}{{A}_{f}}$$

Where S(s) is the propagation velocity, A(f) is the total flame front area and a(f) is the cross-sectional area.

While all blends of HFO-1234yf and R-161 would be desirable, the preferred blends with advantageous flammability for a heat pump (i.e., operating in the heating or cooling mode) fluid are 99 wt % HFO-1234yf to 78 wt % HFO-1234yf and 1 wt % R-161 to 22 wt % R-161, with more preferred blends being 99 wt % HFO-1234yf to 80 wt % HFO-1234yf and 1 wt % to 20 wt % R-161 and most preferred blend being 99% HFO-1234yf to 90 wt % HFO-1234yf and 1 wt % R-161 to 10 wt % R-161.

### EXAMPLE 4

Thermal stability of inventive refrigerant compositions was measured in accordance with ANSI/ASHRAE 97. Stability tests for refrigerants with metals was performed neat and in the presence of POE lubricants with or without added air.

Samples of refrigerant or refrigerant/lubricant with or without added air were placed in thick-walled borosilicate glass tube. The tubes are about 16 mm outside diameter, and about 17 cm in length when sealed. The glass tube used is able to withstand the higher pressures of the refrigerant/additive systems used for testing. In addition to refrigerant and additives (e.g., lubricant, air and moisture), a metal coupon bundle consisting of one strip each of copper, aluminum, and steel, separated by copper spacers and held together with a copper wire is added to each tube. Metal coupons are cleaned by surface grinding just prior to being added to a pre cleaned glass tube. The metal coupons provide a catalytic surface to simulate an actual refrigeration system. Then, the prepared/sealed glass tubes are placed in a heated oven for 2 weeks at the desired testing. Testing is done at higher temperatures, 150C-200° C., to accelerate any potential chemical reactions/product degradation.

Quantitative (fluoride ion and TAN) and qualitative (visual observations) data was generated with pre-oven testing, after oven aging for one week and after two weeks oven aging.

Thermal Stability of blend of 90% 1234yf/10% 161 was determined. Sealed tubes were prepared according to ANI/ASHRAE 97 and placed in a 150° C. oven for two weeks.

All testing was done using metal coupons (Al, Cu, Steel). The results of the testing are shown in Table 13.

TABLE 13

| | | | Visual | | | | |
|---|---|---|---|---|---|---|---|
| | | | Observation | Visual | Visual | | |
| | Type | Air | (before | Observation | Observation | | TAN, |
| | of | (cal | 150° C. | (after 1 week | (after 2 week | F-Ion | mg |
| Refrig | Oil | vol %) | Oven) | 150° C. Oven) | 150° C. Oven) | (ppm) | KOH/g |
| 90% | None | 0 | Liquid is | Liquid is clear | Liquid is clear but | <50 | |
| YF/ | | | clear and | but have very | have very slight | | |
| 10%161 | | | metal | slight tint on | tint on copper | | |
| | | | coupons are | copper coupon | coupon. No flocs | | |
| | | | clean. | | or gelling of liquid. | | |
| 90% | None | 1.5 | Liquid is | Slight yellow | Slight yellow | <500 | |
| YF/ | | | clear and | discoloration | discoloration in | | |
| 10%161 | | | metal | in liquid. Steel | liquid. Steel and | | |
| | | | coupons are | and copper | copper coupons | | |
| | | | clean. | coupons both | both show heavier | | |
| | | | | show | corrosion. No | | |
| | | | | corrosion. | flocs or gelling of | | |
| | | | | | liquid. | | |
| 90% | POE * | 0 | Liquid is | Liquid is clear | Liquid is clear but | <50 | 0.75 |
| YF/ | (Auto) | | clear and | but have very | have very slight | | |
| 10%161 | | | metal | slight tint on | tint on copper | | |
| | | | coupons are | copper coupon | coupon. No flocs | | |
| | | | clean. | | or gelling of liquid. | | |
| 90% | POE * | 1.5 | Liquid is | Slight yellow | Slight yellow | <100 | 0.44 |
| YF/ | (Auto) | | clear and | discoloration | discoloration in | | |
| 10%161 | | | metal | in liquid. Steel | liquid. Steel and | | |
| | | | coupons are | and copper | copper coupons | | |
| | | | clean. | coupons both | both show | | |
| | | | | show | corrosion. Copper | | |
| | | | | corrosion. | plating to steel. No | | |
| | | | | | flocs or gelling of | | |
| | | | | | liquid. | | |

* POE tested was Idemitsu ND-11, an automotive lubricant.

Previous studies conducted by Leck et al found that R-161 had poor thermal stability for use as a HVACR refrigerant (see Ref Laboratory Studies of Stability of Low GWP Refrigerants Thomas J Leck, Bianca Hydutsky, Fluorochemicals Research, DuPont Company, Wilmington, DE, 19880 USA; JRAIA INTERNATIONAL SYMPOSIUM 2012; the disclosure of which is hereby incorporated by reference). Leck noted that the R-161 molecule is chemically unusual because it easily decomposes to form HF and ethylene. Leck reported that sealed tube tests at 150° C. found extensive formation of solids and gel, if any air was present. GC/MS analysis confirmed the presence of significant levels of ethylene after thermal aging. Leck, et al also noted that when either MO or POE lubricant was aged with HFC-161 extensive discoloration of the sample was observed. Visual analysis of the sealed 161/POE tubes found that the samples were dark brown to black indicating degradation of the refrigerant/lubricant system and possible “coking” of the lubricant portion of the sample. Leck also noted that there were very high TAN (total acid number) values in this study such that the titrator had difficulty identifying an end point even after samples were diluted, further indicating R-161 degradation.

In contrast to previous reports regarding the thermal stability of R-161, this Example demonstrates unexpected and desirable results including that the 90%YF/ 10% 161 has improved thermal stability over the neat R-161 system. This is unexpected as the 1234yf has a double bond and it would be expected to degrade in this type of testing. Another unexpected result is that the inventive compositions (for example, 90% YF/10%161) and POE may be used without adding a lubricant stabilizer. Further, this Example demonstrates that there was no generation of flocs (particulates) or gelling of liquid in presence of POE lubricant with air and metal coupons. Further still, the fluoride ion level was very low (<50 ppm for the 90%YF/ 10% 161/POE system and <100ppm 90%YF/10% 161/POE/1.5 vol % air system) further indicating that the YF/161 system had unexpected stability compared to previous neat HFC-161 results

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A refrigerant composition comprising:
2,3,3,3-tetrafluoropropene (HFO-1234yf) and fluoroethane (HFC 161).

2. The composition of claim 1:
wherein the fluoroethane (HFC-161) is present in an amount between 1 weight percent and 20 weight percent based on the total refrigerant composition.

3. The composition of claim 2:
wherein the fluoroethane (HFC-161) is present in an amount between 1 weight percent and 15 weight percent based on the total refrigerant composition.

4. The composition of claim 3:
wherein the fluoroethane (HFC-161) is present in an amount between 1 weight percent and 10 weight percent based on the total refrigerant composition.

5. The composition of claim 4:
wherein the fluoroethane (HFC-161) is present in an amount between 1 weight percent and 7.5 weight percent based on the total refrigerant composition.

6. The composition of claim 5:
wherein the fluoroethane (HFC-161) is present in an amount between 4 weight percent and 6 weight percent based on the total refrigerant composition.

7. The composition of claim 1, wherein the heat capacity of the refrigerant composition is between 0.9% and 10.8% greater than the heat capacity of 2,3,3,3-tetrafluoropropene (HFO-1234yf) alone.

8. The composition of claim 1, wherein the heat capacity of the refrigerant composition is between 0.7% and 6.9% greater than the heat capacity of 2,3,3,3-tetrafluoropropene (HFO-1234yf) alone.

9. The composition of claim 1, wherein the refrigerant composition is a heat pump fluid.

10. The composition of claim 1, wherein the GWP of the refrigerant composition is less than 10.

11. The composition of claim 1, wherein the refrigerant composition has a temperature glide of less than or equal to 0.5 Kelvin (K) at temperatures of 30° C. up to 10° C.

12. The composition of claim 1, wherein the refrigerant composition has a temperature glide of less than or equal to 0.1 Kelvin (K) at temperatures of 30° C. up to 10° C.

13. The composition of claim 1, wherein the refrigerant composition has a temperature glide of less than or equal to 0.1 Kelvin (K) at temperatures of 20° C. up to 40° C.

14. The composition of claim 1, wherein the refrigerant composition has a temperature glide of less than or equal to 0.05 Kelvin (K) at temperatures of 20° C. up to 40° C.

15. The composition of claim 1, wherein the refrigerant composition is near azeotropic.

16. The composition of claim 1 further comprising at least one additional compound:
a) comprising at least one member selected from the group consisting of 244bb, 245cb, 254eb, 1234ze, 12, 124, TFPY, 1140, 1225ye, 1225zc, 134a, 1243zf, and 1131,
b) comprising at least one member selected from the group consisting of ethylene, diethyl ether, ethyl ether, ethane, butane, isobutane, CO2, HFP, TFPY, ethyl chloride, and acetone; or
c) combinations of a) and b);
wherein the total amount of the additional compound comprises greater than 0 and less than 1wt % of the composition.

17. The composition of claim 1 further comprising at least one additional compound:
a) comprising at least one member selected from the group consisting of 134, 23, 125, 143a, 134a, 1234ze, 1243zf, 245fa, 1131, 1122, 244bb, 245cb, 1233xf, 1224, 1132a, 1131a, 12, and HFP,
b) comprising at least one member selected from the group consisting of ethylene, diethyl ether, ethyl ether, ethane, butane, isobutane, CO2, HFP, TFPY, ethyl chloride and acetone; or,
c) combinations of a) and b);
wherein the total amount of the additional compound comprises greater than 0 and less than 1wt % of the composition.

18. The composition of claim 1 further comprising at least one additional compound:
a) comprising at least one member selected from the group consisting of methane, ethane, 143a, 1234ze, ethylene oxide, 1123, 1243zf, propane, 23, 263fb, 124, 254eb, 1224yd,
b) comprising at least one member selected from the group consisting of ethylene, diethyl ether, ethyl ether, ethane, butane, isobutane, CO2, HFP, TFPY, ethyl chloride and acetone; or,
c) combinations of a) and b);
wherein the amount of the additional compound comprises greater than 0 and less than 1wt % of the composition.

19. The composition of claim 16 wherein the fluoroethane (HFC-161) is present in an amount between 1 weight percent and 15 weight percent based on the total refrigerant composition.

20. The composition of claim 17 wherein the fluoroethane (HFC-161) is present in an amount between 1 weight percent and 15 weight percent based on the total refrigerant composition.

21. The composition of claim 18 wherein the fluoroethane (HFC-161) is present in an amount between 1 weight percent and 15 weight percent based on the total refrigerant composition.

22. The composition of claim 19 wherein fluoroethane (HFC-161) is present in an amount between 1 weight percent and 10 weight percent based on the total refrigerant composition.

23. The composition of claim 22 wherein the additional compound comprises (a).

24. The composition of claim 22 wherein the additional compound comprises (b).

25. The composition of claim 22 wherein the additional compound comprises (c).

26. The composition of claim 1 further comprising a POE lubricant, wherein the composition optionally has at least one of an F-ion of less than about 500 ppm and a TAN, mg KOH/g number of less than about 1.

27. (canceled)

28. (canceled)

29. A refrigerant storage container comprising the composition of claim 19 wherein the composition comprises gaseous and liquid phases and wherein the oxygen and water concentration in the gas and liquid phases ranges from about 3 vol ppm to less than about 3,00 vol ppm at a temperature of about 25C.

30. A heating or cooling system comprising, in a serial arrangement:
a refrigerant,
a condenser;
an evaporator; and
a compressor, the system further comprising each of the condenser, evaporator and compressor operably connected, wherein the refrigerant comprises the composition of claim 1 and is circulated through each of the condenser, evaporator and compressor.

31. The heating or cooling system of claim 30:
wherein the system is an air conditioner for one of an automotive system and a stationary cooling system.

32. (canceled)

33. The heating or cooling system of claim 30:
further comprising a 4-way valve.

34. The heating or cooling system of claim 33:
wherein the system is a heat pump for one of an automotive system and a residential heating or cooling system.

35. (canceled)

36. The heating or cooling system of claim 34:
wherein a temperature glide is less than 0.1 Kelvin (K).

37. The use of the refrigerant composition of claim 1 in a heat pump system.

38. The use of the refrigerant composition of claim 1 in an HEV, MHEV, PHEV, or EV heat pump system.

39. The use of the refrigerant composition of claim 1 in an HEV, MHEV, PHEV, or EV heat pump system in combination with a vehicle electrical system.

40. A method of charging a refrigerant composition to an automotive system comprising:
providing the composition of claim 1 to an automotive heating or cooling system.

41. A method for improving gross contaminants from a refrigerant composition comprising:
providing a first refrigerant composition;
wherein the first refrigerant composition is not near azeotropic and includes 2,3,3,3-tetrafluoropropene (HF0-1234yf) and fluoroethane (HFC-161), providing at least one of 2,3,3,3-tetrafluoropropene (HFO-1234yf) or fluoroethane (HFC-161) to the first refrigerant composition to form a second refrigerant composition;
wherein the second refrigerant composition is near-azeotropic.

42. The method of claim 41, wherein the second refrigerant composition is formed from the first refrigerant composition without the use of conventional onsite automatic recovery, recycle, recharge equipment.

43. The composition of claim 1 wherein the composition has a flammability rating of 2L (when measured in accordance with ANSI/ASHRAE Standard 34), a BV of less than 10 cm/sec (when measured in accordance of ISO 817 vertical tube method), and an LFL of less than 10 vol % (when measured in accordance with ASTM E681).

44. The composition of claim 1 wherein the composition has a flammability rating of 2L when further comprising up to 5 wt % of perfluoropolyether lubricant.

45. A method for heating or cooling a passenger compartment of an HEV, MHEV, PHEV, or EV using the system of claim 1 and a refrigerant comprising the composition of claim 19.
